(19) United States
(12) Patent Application Publication
(10) Pub. No.: US 2015/0096426 A1
(43) Pub. Date: Apr. 9, 2015

(54) Contoured pick and a method of multiple variations of 3D CAD models

(71) Applicants: Matthew A. Culver, Redding, CA (US); Patrick J. Tennant, Redding, CA (US); Mark Cooper, Redding, CA (US)

(72) Inventors: Matthew A. Culver, Redding, CA (US); Patrick J. Tennant, Redding, CA (US); Mark Cooper, Redding, CA (US)

(73) Assignee: Bionic Pick, Inc., Redding, CA (US)

(21) Appl. No.: 13/998,186

(22) Filed: Oct. 8, 2013

(51) Int. Cl. G10D 3/16; G06F 17/50

(52) U.S. Cl. CPC G10D 3/163; G06F 17/50
USPC 84/322; 700/118

(57) ABSTRACT

The original contoured thumb and finger pick for players of stringed instruments introduced an incredible innovation for guitar players and others. Improvements based on this unique concept have transformed a useful tool into an extremely comfortable and natural strumming aid. The pick saddle totally follows the thumb and finger contours for greater comfort and the band is secured to the pick with a low profile post. A new method of constructing a large inventory of 3d CAD models with the manufacture of individual custom fit models by 3d printing now makes the improved contoured pick available to all sizes and shapes of fingers and thumbs, and allows each player to select a pick which will best fit his own shape, size, and playing style.

The “method of multiple variations of 3D CAD models” for creating a diverse array of “custom fit” finger products also has its application for nearly any category of human personal items made to fit a part of the human body, and an application of this method for the creation of custom fit foot products is presented.

### REFERENCES TO RELATED PRIOR ART

| Patent No. | Inventor | Reference Source |
|---|---|---|
| 8,378,193 | M. Culver et. al | USPTO |
| NA | Mark | USPTO, Pat. App. 20120305003 |
| NA | Fiskar | USPTO, Pat. App. 20120232857 |
| 8,032,337 | Deichmann et. al | USPTO |
| 7,375,268 | Thornhill | USPTO |
| 7,312,386 | Sielaff and Sielaff | USPTO |
| 5,323,677 | Knutson | USPTO |
| 4,843,942 | Ishizuka | USPTO |
| 4,879,940 | Pereira | USPTO |
| 3,739,681 | Dunlop | USPTO |
| NA | unknown | http://www.elderly.com/brand/PKFG_propik.html |
| NA | unknown | Alaska Pik (Advertisement) Fingerstyle Guitar, |
| | | May/June 1998, No. 27, p. 34 |
| NA | unknown | Coimbra pick, |
| | | fernandezmusic.com/Portuguesemethodpage2.html |
| NA | unknown | Fred Kelly Freedom Pick, www.fredkellypicks.com |
| NA | unknown | http://www.technologyreview.com/news/515536/can- |
| | | infinite-variation-be-mass-produced-using-3-d-printing/ |
| NA | unknown | http://www.prnewswire.com/news-releases/shapeways- |
| | | announces-infinite-possibilities-with-over-six-billion- |
| | | product-variations-in-its-marketplace-169171186.html |
| NA | Butdee et. al | Journal of Achievements in Materials and |
| | | Manufacturing Engineering, Vol. 31, December 2008 |
| NA | unknown | http://www.newbalance.com/New-Balance-Pushes-the- |
| | | Limits-of-Innovation-with-3D- |
| NA | unknown | http://www.psfk.com/2013/04/3d-printed-instant- |
| | | shoes.html |
| NA | unknown | http://www.3ders.org/articles/20120813-new-start-up- |
| | | offers-3d-printed-glasses-fit-to-your-face.html |

### BACKGROUND OF THE INVENTION

This invention falls into the category of strumming aids for persons who play stringed instruments and specifically to those aids that are worn upon the finger or thumb. This invention is both an improvement upon an existing invention and a method for creating multiple variations of not only the improvement, but also discloses an application of the method of multiple variations to other items of a human personal nature that are meant to be worn on a part of the human body. The improvement to an existing invention, namely that entitled “Contoured Finger Pick for Stringed Instruments”, invented by Matthew A. Culver et al. will be referred to as “the improvement” throughout the remainder of this specification. The prior art upon which this invention is an improvement will be referred to as “contoured pick”.

In the patent specification of the contoured pick Mr. Culver addresses six problems that his invention solves over prior art. The problems with existing finger and thumb picks are as follows:

(1) The pick causes discomfort after a few minutes of use.
(2) The pick interferes with the player's natural playing style.
(3) It requires the player to learn a new picking style.
(4) It slips from position while in use and requires frequent readjustment.
(5) It doesn't produce the desired sound of a conventional plectrum
(6) Unwanted sounds are made when the user inadvertently touches an adjacent string.

In fact, the contoured pick does solve these problems but introduces a few new problems. The problems with the contoured pick are as follows:
(1) The band of the contoured pick covers too much of the fingertip and interferes with the playing of the instrument.
(2) There is not an adequate securing means of the band to the pick saddle.
(3) The abrupt corners on the upper surface of the pick flange as it attaches to the saddle inhibit the smooth playing of “backstrokes”.
(4) On the picks for fingers, not thumbs, the saddle extends in a lateral direction too far over the side of the finger and causes noise if it contacts an adjacent string.

In addition to solving the problems with the contoured pick this invention discloses three additional novel features. This improvement to the prior art pick provides (1) a pick element and a modified lower saddle surface for the thumb pick to replace the pick flange, and (2) a special design feature which causes the pick saddle to be much more flexible, thus adding to the comfort of the pick.

This specification also discloses a unique method of creating multiple variations or embodiments of three dimensional (3D) computer models of items of a human personal nature made to be worn on a part of the human body, of which the thumb and finger picks disclosed herein are an application. This is a method of which limited prior art exists. The advantage of creating multiple variations is for a very novel purpose, the ultimate goal of which is to make a wide range of sizes, shapes, and style features of the improved picks of this invention, the result being that any person can be matched to a size, shape, and style that closely approximates his own personal size, shape, and playing style. There is no prior art within the field of picking strumming aids that exists for comparison. It should be noted also that there is no identical prior art for any other field of invention which would benefit from the method of multiple variations of 3D CAD models disclosed herein.

The category of market products of which this invention is a part has many such finger pick products available as limited variations of a single basic shape. These include the Fred Kelly Freedom pick, the Propik Fingertone pick, the Alaska Pik, and the Dunlop pick. These all have the same single variation which is the size of the pick, and the sizes of these four products in particular are available only for larger adult sizes. There are no smaller sizes that are specifically for women and children. In addition, all these aforementioned picks are symmetrical in design meaning that they can be divided into two halves of which each is a mirror image of the other. As a matter of fact, all existing finger and thumb picks have this characteristic with the exception of this invention and the prior art of which this invention is an improvement upon. Being symmetrical, they are made to be worn for both right and left handed players. And being symmetrical they fail to address the way in which strings are naturally played.

All existing finger picks with the exception of this invention are made with a single shape for a particular product. It has been shown in the contoured pick specification that a multitude of shapes of the “contoured pick” can be created, depending on the unique shape of a finger or thumb of an individual person, and a process for making the contoured pick was disclosed. The process for making the contoured pick however does not allow for making many uniquely shaped picks quickly. However this invention discloses a different process for constructing the pick that not only creates the pick from individual fingers, but uses a computer model made from a single finger or thumb that can be altered in such a way so that multiple variations of the original model can be created with the result that one of the variations will closely approximate the thumb or finger shape of any person. Matching the shape of the finger or thumb is the advantage of both the contoured pick of prior art and the improvement disclosed herein, so that the contoured shape of the pick saddle not only creates a finger pick that is comfortable to wear but also stays in place and feels very natural, much like playing without any strumming aid at all. So the goal of the creation of multiple variations is to establish a large inventory of 3d computer models so that nearly all possible finger and thumb shapes and sizes are represented, to the effect that at least one size, shape, and playing preference style can be found for any individual.

Until the time of this writing all existing finger pick products available for sale to the public have been manufactured using one of several methods which are known to most people as “mass manufacturing”. These methods almost exclusively use injection molding or sheet metal forming and shaping. One manufacturing technique that is not used at all is commonly known as 3d printing. This technology is relatively new and has been in use commercially since the early 1990s for producing prototype parts.

Finger picks aside, many people seem to understand that 3d printing could eventually be used to produce consumer parts in large volumes cheaply enough to make them affordable to the general public, but apparently no one has yet figured out a way to do it. At the present time the cost of the machines, the relatively high cost of their materials, rougher surface finish, and their slower production rates in comparison to injection molding has kept the production cost too high to enable large volumes of products to be made for sale at a low enough price for the competitive consumer market.

Many people however do realize that although 3d printing has a way to go in replacing traditional manufacturing methods such as injection molding, it may first find wide acceptance in the consumer market for items which could be customized according to a customers preference in style, size, and shape. These one-of-a-kind items are impossible for other mass production techniques to produce cost effectively, but such items are ideal for 3d printing. If only there was a way to quickly do the customization. Several individuals and companies are currently working to solve this problem in different ways.

Shapeways, a 3d printing manufacturing company, announced in 2012 that they have 6 billion variations of products available on their website, products that have entirely been created by individuals who are not employees, but created by artists and craftsmen who use the 3d printing service of Shapeways to manufacture their products. And many of those artists then offer their creations for sale to the public on the Shapeways website. Shapeways also states that they are working to “design an automated process for infinite variation,” although the online article does not specify how or for what kinds of things will have variations. “Automated process” however implies that the procedure for making the variations can be run by software in real time. They state that the software is currently being developed.

Others have filed patent applications for related methods to produce personal customized items. Philip Mark, author of U.S. patent application 20120305003, discloses a method of making CPAP masks using electronic scans of a patients face, followed by a CNC milling to produce a mold from which the part will be made. This does not involve multiple variations of a single model made from a face scan and therefore is non-relevant to this invention.

Fiskar, Rune, et al, U.S. Patent application 20120232857, disclose a method for making a custom ear mold for a hearing aid using 3D CAD software and manufactured by 3D printing. This method also attempts to efficiently produce each product from single individual surfaces, rather than one surface which then undergoes variations.

Deichmann et al, U.S. Pat. No. 8,032,337, also describes a method for simplifying the process of constructing a 3D CAD model of an earpiece housing, and the method requires a complete CAD construction of each earpiece.

There are several online disclosures of advances in constructing custom personal products. A specialty sports shoe company, NewBalance, produces custom made athletic shoes but produces them one at a time from individual foot scans. Pavia Podsednikova, a designer of women's shoes, says she is “looking to the future—everyone can have a digitized 3D scan of their feet, according to which . . . shoes could be produced. It would not be a problem to change the design of the shoes (could be a collection of designs on the Internet) and then manufacture the shoes exactly according to the desired proportions.” This is the expectation of many people, that custom, personal items could be quickly designed and manufactured with 3d printing.

Protos, a company in S.F., CA, offers custom, made to fit sun glasses but makes them one at a time rather than drawing from a database of thousands of shapes for a perfect match.

Butdee, et al, disclose a method of creating a repository of CAD models of shoes designed specifically to fit Thai people, whose feet are more narrow than standard shoe sizes. This is a database of limited shoe sizes, however, and approximates the number of choices shoe customers now have in most places of the world.

This invention discloses a strategy in which the primary goal is to not produce a cheaper part, but to produce a computer model of a product which becomes more valuable by existing in multiple varieties of sizes and shapes. If a customer desires to have a part which is made for a very specific purpose, for example, to be an item which he wears on his body, then the item must be of a shape and size to match his surface features. These kinds of items are those which would benefit a person seeking something which would be more tailored to his person than having a choice of small, medium, or large. Typical examples would be shoes and shoe parts, gloves, headgear including goggles, glasses, helmets and other protective gear, and items specially designed for hands, feet, and fingers. These all can be conveniently designed and manufactured in large volumes by the method of multiple variations in combination with 3d printing when used under the conditions disclosed herein.

### SUMMARY

The object of this invention is to solve some problems with the contoured pick which turn it from a useful and novel product into an amazing high performance strumming tool which will fit any persons finger or thumb and be just what he needs for the way that he plays. The elastic band has been slimmed down and is free from contacting strings. The top surface of the pick has been smoothed so a string does not catch on corners on backstrokes. The extra material on the sides of the finger pick has been eliminated to create a low profile so the playing experience is very clean and unobstructed. The flat flange of the contoured pick for the thumb has been replaced with a naturally curved undersurface which gently squeezes the underside of the thumb to keep the thumb surface snug against the pick. And the elastic band which holds the pick in place is secured to the top surface of the pick saddle by threading it through a post.

Perhaps the most useful and novel aspect of this invention is the way in which the method of multiple variations of 3D CAD models can be used to create multiple personalized products without actually having to keep an inventory of the physical items themselves. This method is a practical way which makes the link between 3d printing and custom personal products so that these products can be affordable and accessible to every person.

### DESCRIPTION

### Main Embodiment

An improvement of the elastic band used to hold the pick in place on the finger involves decreasing the width so that more of the fingertip is uncovered. This allows unhindered movement of an instrument string across both lower and upper surfaces of the finger and the pick saddle. FIGS. 1 and 5 show a top view and side view respectively of the prior art “contoured pick” for a thumb. It can be seen that the band (5) covers much of the surface of the distal digit—so much so that only a small part of the fingertip is left uncovered. The distal digit is the part of a finger or thumb past the last joint and terminating at the tip of the finger or thumb. The original advantage of this particular design of the band was to maximize the securing of the saddle into it's position on the finger. After extensive testing of this design the author has concluded that this is too excessive, and that this much use of the band is overdoing it. Feedback from other persons using this pick indicates that the band also tends to interfere with the free movement of the string across both the undersurface of the finger on a down stroke, and across the upper surface of the saddle on a back stroke. FIGS. 2 and 6 show a top view and a side view of the band of the improvement (6). These drawings show that nearly the entire fingertip area is now exposed with the improvement.

The securing means of the elastic band to the pick saddle is perhaps the weakest part of the entire design of the contoured pick. The preferred embodiment of the contoured pick uses an eyelet (1) near the fingertip area of the saddle to hold the elastic band in place on the saddle (see FIGS. 1 and 5). This is not an ideal solution for several reasons. Eyelets used to hold any elastic material don't work very well. The material tends to stretch itself to the point of pulling away, and this frequently occurs when the contoured pick is put in place on the finger. The band is stretched quite a lot to get the pick to seat properly and comfortably. Eyelets tend to introduce a high stress area on the elastic band so that it tears.

Another problem occurs when a band needs to be replaced because eyelets are difficult to remove. Also it requires the user to reinstall a new eyelet with each new band. It is anticipated that most potential users of the contoured pick will balk at having to do this each time the band needs to be replaced.

This invention introduces a new design which completely solves this problem with the securing of the band. The improvement to the contoured pick uses a securing “post” (2) which is essentially a “U” shaped groove carved into the upper surface of the pick saddle. FIG. 4 shows a top view of a thumb pick of this invention, with the elastic band omitted for clarity. FIG. 3 shows the same view of the prior art contoured pick, also without the band. The post in FIG. 4 can be seen at the center of the upper part of the pick saddle, mostly covering the fingernail area. FIGS. 2 and 6 show top and side views of the invention with the elastic band in in place by threading it through this post. This produces absolutely wonderful results.

Another problem mentioned by some using the contoured pick occurs when the player does a “backstroke”. Although players using finger picking as their preferred method of playing use mostly forward strokes, the majority of players hold a flat pick and play with both forward and back strokes. Those players would be more likely to use a finger pick if there was one that would always allow then to do both forward and back strokes in the same way a flat pick is used. The design of the contoured pick does not work well with this style, and for a simple reason. The way in which the pick flange is attached to the saddle leaves an abrupt corner (3) on the top side of the pick, where a string traveling across this surface can easily catch on a backstroke. FIG. 5 shows this problem corner.

This invention provides the solution. The improvement eliminates the corner and provides a smooth continuous surface (4) over the upper part of the pick. This design change has been incorporated on both thumb and finger picks. This now allows forward and backstrokes to be played on all fingers with nothing impeding the movement of the pick across the strings.

One improvement to the contoured pick has been done to enhance the performance of the contoured pick specifically for the fingers. This improvement is the removal of much of the saddle surface near the fingertip as shown in FIGS. 83 and 85. FIGS. 84 and 86 are the same respective views of the contoured pick for comparison.

This concludes the description of this invention's solutions to the four problems of the contoured pick. This invention discloses two additional novel features which are also improvements to the contoured pick. First, this invention eliminates the “pick flange” (9) of the contoured pick which is essentially the entire lower surface of the contoured pick. This is a planar surface attached to the lower perimeter of the contoured portion (pick saddle).

The pick flange is replaced with two elements, the first being an extension of the pick saddle extending past the upper (dorsal) part of the finger or thumb and covering a portion of the lower surface. This extension on the lower part of the saddle is called the encroachment surface (10) as shown in FIG. 17 for a thumb pick. In this drawing a line is shown called the encroachment boundary (46) which marks the upper boundary of this part of the modified pick saddle. FIG. 18 shows a similar view of the contoured pick for comparison.

The second element of the improvement that replaces the pick flange of the contoured pick is called the pick element (11). This can be seen in FIG. 17 for a thumb pick and can be described as a thin protrusion from the lower inside tip of the pick saddle.

The improvement to the contoured pick for fingers also incorporates the same encroachment surface (10) as the thumb pick with the saddle being extended past the upper surface of the finger and continuing partially onto the underside. FIG. 83 shows this feature and the encroachment curve (16) and FIG. 84 shows the prior art contoured pick for comparison.

The pick element for the finger pick (74) has a different shape than the pick element for the thumb. FIGS. 83, 85, 87 and 88 show that the finger pick element is a somewhat oval shaped ring-like structure and extends from a lower proximal position on one side of the finger, traveling toward the fingertip along half of its oval path, rounding the tip and returning toward its termination on the lower proximal part of the other side of the finger. This is in comparison to the pick flange (3) of the contoured pick shown in FIGS. 84 and 86 which is a flat, thin sheet in a somewhat crescent shape attached to the lower distal surface of the pick saddle. A very important feature is the shape of the pick element. In FIGS. 87 and 88 it can be seen that the distal portion of the pick element varies in width between the right and left sides of the pick as seen in these perspectives, with the width on the left side (75) being greater than the right side (76). This makes the pick asymmetrical and has a specific functional purpose as will be disclosed later. All other prior art finger picks do not have this design feature.

The second novel feature of this invention allows control of the flexibility of the saddle portion of this invention. This is accomplished by controlling the wall thickness of the pick saddle. Many materials can be used in the composition of the pick saddle (body) but the best results are obtained with materials that have some flexibility. Greater flexibility of any material is obtained with thinner wall thicknesses. This invention is currently manufactured of nylon-12 (polyamide 2200) using a 3d printing technology known as selective laser sintering (SLS). With SLS 3d printing as the method of manufacture the wall thicknesses are limited to somewhat less than 1 millimeter. It should be noted that any manufacturing process which can accommodate this wall thickness and lesser wall thicknesses can be used to manufacture the finger or thumb pick of this invention. Injection molding and 3d printing are two examples of such a manufacturing process.

This invention currently uses a wall thickness of less than 1 millimeter for most of the saddle portion of the pick body. As manufacturing materials and 3d printing processes improve it is anticipated that this invention will also be manufactured with even thinner walls in order to gain even greater flexibility.

This invention also discloses a method of creating multiple variations of 3d CAD models of the improvement to the contoured pick of prior art, the multiple differing models being formed from a single thumb or finger surface. It was described in the specification of the prior art contoured pick that the saddle portion of the pick is made by manually modifying a model of the distal digit of a finger or thumb, followed by forming a shell of the material of choice over this modified model, trimming the resultant shell and attaching a pick flange to the shell. This invention uses an entirely different approach to incorporate the features of the prior art contoured pick and the improvements disclosed herein in the process of making a model of a single pick of this invention, and then uses the completed model to construct additional models which are variations of the original model.

The construction of a single pick saddle model of this invention followed by the creation of multiple variations of the single model is currently done as a combination of four steps using three different technologies. The first step is the use of three dimensional (3D) scanning to generate a “likeness” of a thumb or finger surface. In the same way that a thumb or finger surface was used as a starting point for the contoured pick, this invention also starts with the same surface. The distal digit of a finger or thumb or a model thereof is scanned using a 3d laser scanner, although any optical scanning or contact device which will render a set of three-axis coordinate points that define the surface in three dimensional space will work. The result of the scanning is a collection of points as shown in FIG. 19, a single target point being defined by three distances, a single distance being measured along its corresponding single axis (x, y, or z axis) from the origin (0,0,0) to a single point on the single axis at which a plane perpendicular to the single axis intersects the target point.

In the following construction steps it's helpful to have some reference points within the virtual three dimensional space for working with 3D models. It is useful to put an origin, which is a point located at 0,0,0 on the xzy coordinate axes at the very tip of the finger or thumb surface. This point will also define the position of a longitudinal axis which will be a simple straight line that passes through the origin and continues lengthwise toward the middle of the base of the distal digit. In doing so, it is constructed so that it is as parallel as possible to the line of the fingernail or thumbnail when viewed from the side. See FIGS. 25 and 26.

The second step of the process of creating multiple variations of this invention is to create a three dimensional virtual computer model of the pick. This begins with the importation of the collection of points obtained from the first step into computer software known as three dimensional computer aided design software, or 3D CAD software. The collection of points is then used as input into a CAD software module which can create either a network of intersecting mathematical curves (FIG. 20) or a set of connected polygons (FIG. 21). Either of these resulting 3D CAD finger surfaces is used as the starting point to create a virtual solid model of this invention.

It should be mentioned at this point that an alternative to the 1^{st} step of this process up to the creation of a CAD finger or thumb surface described in the 2^{nd} step would be to use an existing CAD model of a human finger or thumb, many of which can be downloaded from various 3D CAD model repositories existing on the internet. The example which continues in the remainder of this description and the accompanying drawings are for a right handed thumb pick, and will use a thumb surface (12) consisting of a network of mathematical curves as shown in FIG. 20. A surface consisting of a network of curves is a series of longitudinal curves (13) that run in a longitudinal direction and define the shape of the surface in that direction, combined with lateral curves (14) that define the objects shape and are perpendicular to the longitudinal curves.

Following the creation of a three dimensional curve network of a thumb surface as described above, a curved line is drawn upon the upper surface of the thumb model which will define the perimeter of the invention on the upper side of the pick saddle. See FIG. 22. This line will be called the contour curve (15) and is shown as the solid curved line lying on the upper surface of the thumb model. A thumb nail (17) has been drawn on the surface for clarity of the drawing.

A second curved line is drawn which connects the ends of the contour curve and passes through the lower (lower) side of the thumb surface. This second line is called the encroachment curve (16) because instead of lying on the surface, it encroaches past the surface. It can be seen in FIG. 22 as the broken line extending beginning at the one end of the contour curve, then continuing past the lower surface of the thumb model and ending by joining with the other end of the contour curve. Three additional views of both of these curves can be seen in FIGS. 23, 24, and 25. It can be seen in the front views of both FIGS. 23 and 24 the path that the lower encroachment curve takes and that its encroachment in the vertical direction past the lower surface of the thumb is substantial.

The contour curve and the lower encroachment curve are then connected to form one continuous closed curve, called the inner perimeter curve (18) shown in FIG. 26. FIGS. 27 and 28 show the inner perimeter curve without the thumb surface in two different views. An outline of the thumbnail is shown for clarity in all three of these drawings.

Then a modified thumb surface (21) is constructed (FIG. 30), beginning by redrawing the longitudinal and lateral curves of the original thumb surface. These modified longitudinal curves (19) and modified lateral curves (20) are drawn so that they intersect the inner perimeter curve, causing the modified thumb shape to conform to the outline of the inner perimeter curve. As these modified surface curves are drawn they begin at a line that runs longitudinally upon the original unmodified thumb surface called the upper encroachment boundary (46). The lateral curves are drawn so that they gradually depart from the original surface beginning from the upper encroachment boundary, make a smooth transition to where they end at the encroachment curve as shown in FIG. 30. FIG. 29 shows a greatly simplified drawing in which only four of the modified longitudinal lines and five of the modified lateral lines are shown. Five of the original lateral lines and the lower original longitudinal lines are also shown as dashed curves. Comparison of the original curves with the modified curves shows how the original thumb surface is trimmed on the underside to form the inner surface of the invention. In this drawing the inner perimeter curve has been omitted so that the modified surface curves can be clearly seen.

Then the modified thumb surface is formed from the modified longitudinal and lateral curves as shown in FIG. 30. The inner perimeter curve is again shown in this drawing, lying entirely upon the new modified surface. The inner saddle surface (22) is then created by trimming the modified thumb surface with the inner perimeter curve as shown in FIG. 31. This surface will be the inner surface of the finished pick model. The portion of the inner surface below the upper encroachment boundary is called the encroachment surface (10). A few of the original lateral curves and the lower longitudinal curve of the original thumb surface is shown for comparison, just as in FIGS. 29 and 30. FIGS. 32 and 33 show alternate views of the inner saddle surface, also with a few of the original curves shown for clarity.

A second saddle surface, called the outer saddle surface (23), is then created by offsetting the inner saddle surface (FIG. 34). This is a common function in 3D CAD programs so that creating the offset surface involves no more than specifying the direction and the distance of the offset. The actual function of the offset creates a second surface in such a way that each point of the offset surface corresponds to an origination point on the input surface so that a line drawn between the two points is normal (perpendicular) to each surface at the point of its intersection with both surfaces. The offset distance (24) determines the wall thickness of the pick saddle, the approximate dimensions of which have been described earlier.

It should be noted that in nearly all of the drawings depicting this invention there are very few dimensions given. The reason for this is the nature of the object of this invention. As it has been formed based on the shape of a human anatomical part it is known in the world of 3D CAD modeling as a free form shape, and this type of CAD modeling is known as free form modeling. This is in comparison to parametric modeling of which all machined items can be categorized. With free form modeling there are no straight lines of specific lengths, angles of a specific degree, screw threads or circular diameters which can be identified and measured. The only sense of size and proportion can be gained by an awareness of what a thumb, finger, hand, or foot looks like, and the approximate size and range of sizes of these known entities can have. Free form shapes occur routinely in nature, however, nearly all man-made items have a parametric design with the exception of this invention.

At this point an inner surface and an outer surface have been created, using the original thumb surface which was modified to fit the outline of the inner perimeter curve. Next an outer perimeter curve (25) is formed from the perimeter of the outer surface as shown in FIG. 34, and a number of perimeter connecting strip lateral curves (26) are drawn to define the lateral curvature of the perimeter connecting strip (27) as shown in FIG. 35. Then the perimeter connecting strip is created from the inner and outer perimeter curves and the corresponding lateral curves. This ribbon-like surface is shown in FIG. 36. Then the saddle inner and outer surfaces and the perimeter connecting strip are joined together to form a closed volume (FIG. 37). This closed volume in the world of three dimensional CAD models is called a solid. This enclosed volume is the basic unmodified pick saddle of this invention, which in combination with an elastic band would constitute one embodiment of this invention.

The solid shown in FIG. 37 is the pick saddle without the post which secures the elastic band to the pick saddle. The post is formed by first drawing two elongated somewhat rectangular shapes with rounded corners into both the inner shell and the outer shell as shown in FIGS. 38 and 39. These closed curves are called the inner post inset curve (28) and the outer post inset curve (29). It's important that the two short ends of the inner post inset curve are slightly longer than the same short ends of the outer post inset curve. The inner and outer shells are then cut with their respective post inset curves and the cut out shapes within the two cuts are saved for later use. These two cut out shapes are the upper post cut out (30), and the lower post cut out (31). The close up drawing of the top of the saddle following the post perimeter cutting operation is shown in FIG. 40. The two recesses that are formed as a result are called the lower post inset and the upper post inset.

The upper and lower post cut outs are shown in FIG. 41. The post is formed beginning by drawing the desired shape on the surface of the post cut outs. The shape curves, called the upper post perimeter (32) and lower post perimeter (33), are shown in FIG. 42 and lie on the surfaces of the two cut outs. Then the two curves are used to trim the two cut outs and the trimmed area is discarded leaving the two shapes shown in FIG. 43, called the post upper (34) and the post lower (35). The upper post perimeter and lower post perimeter curves are shown in FIG. 42 as the solid lines, while the post inset curves are shown also to give perspective to the drawings. FIG. 44 shows the same surfaces but tilted at a better viewing angle and also shows the post inset curves for perspective.

In the same way that the perimeter connecting strip was formed to join the saddle inner and outer surfaces, a post connecting strip (36) is formed to join the post upper and post lower and creating the post (37) shown in FIG. 45.

FIGS. 43, 44, and 45, also show sets of points on the upper and lower post perimeter curves which define the boundaries of the post longitudinal walls (56). These points are called the proximal post boundary points (62) and distal post boundary points. The post longitudinal walls are a portion of the post connecting strip which run nearly the whole length of the post. It can be seen in the drawings that the proximal boundary of the post longitudinal walls is at the base of the post and the distal boundary is near the end of the post where the curves leave the longitudinal direction and follow the semi-oval end of the post upper and post lower. These longitudinal walls will be used later to explain an important feature of the post and post inset.

Then the post inset connecting strip (38) is created using the post inset curves (FIG. 46) as the boundaries for the length of the strip as shown in FIG. 47. When the post inset connecting strip is joined with the post it forms an object which will fit neatly within the cavities of the upper and lower post insets (FIG. 48). This object is the post assembly (39). Then joining the post assembly with the saddle completes the entire saddle assembly. Before that happens one other operation needs to be done. The walls of the post actually overlap (40) the walls of the post inset connecting strip. If the completed object was submitted to the controlling software of a 3d printer or any other computerized manufacturing tool it would either be rejected or be useless because the object would be fused together at this point. The solution for this is either to bend the post upward or downward, and the solution of this invention is to bend it upward. FIG. 49 shows a side view of the post assembly as originally formed and FIG. 50 shows the assembly after the post has been tilted upward from its base.

FIGS. 43 and 47 show proximal post inset boundary points (63) and distal post inset boundary points (65) on the upper and lower post inset curves which mark the boundaries of the post inset longitudinal walls (57). These walls are a portion of the post inset connecting strip. These walls in conjunction with the post longitudinal walls will be used later to explain an important novel feature of the post and post inset.

Now the finished post assembly can be inserted into the post inset cavities on the surface of the saddle as shown in FIGS. 51 and 52. A view of the entire pick saddle with post assembly is shown in FIG. 53. This completes the construction of one embodiment of the pick saddle of this invention. Additional embodiments can be created with the construction of a pick element.

This begins by selecting a segment of the outer perimeter curve which will define the lower boundary of the pick element on the outer saddle, and then drawing an additional curve upon the upper left portion (for a right hand thumb) of the outer saddle surface. These two curves when joined together will form a closed curve called the pick element inset curve (41) as shown in FIG. 54, and will form the boundary of a cavity which will be cut into the outer saddle surface using the pick element inset curve. The edge of this cavity is the pick element inset edge (55). FIG. 55 shows a lower rear view of the saddle following the cut with the pick element inset curve.

A pick element surface, FIG. 56, is constructed having an upper surface (58) and a lower surface (59), the outer edge of its surface matching the cut away area on the saddle surface. This edge of the pick element which will connect to the outer surface of the pick saddle is called the pick element connecting edge (54). It's important to note that the curvature of the pick element surface at the pick element inset edge (55) is such that this part of the element surface is tangent to the outer surface. This is done so that there is a seamless transition between the junction of the pick element and the outer surface of the pick saddle as shown in FIG. 59. (Two views of the pick element are shown in FIGS. 56 and 57, each view corresponding to the view just above it (FIGS. 54 and 55) showing where it would be attached to the saddle. The pick is completed by attaching the pick element to the saddle at the edges of the cavity. The two views, FIGS. 58 and 59 correspond to the same views of FIG. 54-57, and another view is shown in FIG. 60. The thumb pick now is complete and is a completely enclosed volume. This final 3D CAD model is in a form acceptable to be manufactured by any method which accepts 3D CAD models as input, which could be a 3D printer.

But first, for the purposes of this invention it would be submitted as input to the method of multiple variations which will be described later.

The pick of this invention has to be held in place with an elastic band. This is of a shape similar to FIGS. 61 and 62. The portion of minimum width of the band at the top presents a low profile to the instrument strings while the pick is being used to play the instrument. The portion of maximum width of the band at the bottom creates a large surface area in which the band contacts the finger or thumb. In general, a larger area contacting the finger surface allows less constricting force necessary to keep the pick in place, and results in greater comfort for the user.

The band is installed onto the post of the saddle by passing the narrow part under the post as shown in FIG. 63. Then the post is twisted along its longitudinal axis as shown in FIG. 64 and pushed below the surface of the saddle as shown in FIG. 65. Then it post naturally rotates back to its original position as in FIG. 66 and the band is held securely in place against the post and the edges of the post inset. A view of the pick and band in place on a right hand thumb is shown in FIG. 67. This concludes the description of the improvements to the prior art contoured pick.

Now is a good time to introduce a concept which makes it easier to understand the relation between the surface of a human body part and the corresponding surface of a personal item made to “custom fit” the body part. In the case of the thumb and finger picks of this specification, this would be the interior surface of the pick and the surface of the thumb or finger. It was stated earlier that the process of constructing a pick saddle for a thumb pick begins with a thumb model. The thumb model then undergoes a modification in which it is altered so that the resultant pick will fit snugly and properly and perform well. So the resultant item made for the thumb does not have the exact surface of the thumb from which it is made. But the interior surface of the pick saddle is perfect for the surface of the original thumb. They are a perfect match. Although the actual surfaces don't match, the pair is a match. One way to express the concept that the surface of a body part and the interior or contacting surface of the item made for the body part match is to attribute another quality to the original surface. This quality is called the functional surface. The functional surface of the original thumb model used to construct the pick saddle is the modified thumb model. So the use of the term functional surface requires an understanding of three models and not just a pair of models. The three models are the original surface, the modified surface, and the interior surface of the final item made for the original surface. The modified surface is the link between the two and is why it is called the functional surface.

What follows next is a description of a method of creating multiple variations of a single 3D CAD model of this invention and a means to manufacture the resulting multiplicity of various objects made from these 3D CAD models in quantities typically attributed to “mass production” techniques such as injection molding. By single 3D CAD model we mean a model of an object designed for a specific use. Within the scope of the finger and thumb picks of this specification this would be a device to be worn on the finger or thumb to aid in the plucking or strumming of the strings of a musical instrument. By multiple variations we mean one or more of a series of simple one-step variations of CAD models that differ is size, shape, symmetry, and the way in which the resulting objects are used by various individuals. Therefore the method of multiple variations discloses a way to produce multiple variations of objects of a specific use, the multiple variations of these objects originating from a single 3D CAD model which will be called a base model.

A description of the variations possible with this method begins with the shape of a single 3D CAD base model. For the purpose of this invention the shape depends on the shape of the finger or thumb from which the model originates.

At this point it is helpful to identify what features of fingers and thumbs from person to person have different dimensions or shapes. One way in which thumbs differ is what the author terms the “profile angle”. In FIG. 68 four thumbs are shown at a side view, with a dashed line representing an extension of the thumb nail in this view. The curved line with the arrows indicates the angle formed between the line of the thumbnail and the surface of the thumb following the thumbnail going toward the base of the thumb. It can be seen that this angle is different with each of the four thumbs, varying from very little or no angle (42) to a slight angle (43), then a moderate angle (44), and a large angle of nearly 45 degrees (45). An obvious variation of the thumb pick model to accommodate these various profile angles would be to raise or lower that part of the pick surface extending from near the base of the thumb nail toward the base of the thumb as shown in FIG. 69. This is an operation which is easily done with most CAD software because it does not involve creating any additional surfaces. If, for example, three additional profile angle variations are performed then the basic model has been transformed into a total of four models.

A second way in which thumbs differ is the thickness or height as viewed from a side profile. FIG. 70 shows three thumbs at a side view, each thumb having the same profile angle but differing in the height as measured from the base of the thumb nail perpendicularly to the lower edge of the surface. This is an important consideration in the construction of a thumb pick of this invention because correct placement of the lower surface of the pick has a large effect on the performance and comfort of the pick. Most thumbs will fall between these two extremes shown in FIG. 70, therefore it is necessary to make the variations in the relative distance between the upper and lower surface of the pick to fall within the limits shown here. Most 3d CAD software programs have editing features in which the user can select a portion of a completed model and edit that portion only. FIG. 71 shows an example of the effect of such editing on a CAD model of this invention. By editing the 3D CAD base model of the pick in this manner multiple additional models can be created, each varying only in this particular feature. For our example we will perform only three variations. When we combine four profile angle variations with the three thumb thickness variations the result is 12 different model variations.

Another variation in the fingers and thumbs used to play instrument strings is whether the player is right or left handed. One of the advantages of this invention is that it overcomes the problems with existing finger picks which are entirely all symmetrical. A right hand does not play the same way that a left hand does because they are mirror images. Any strumming device which takes advantage of this fact requires a non-symmetrical design which requires that the invention be available for both groups of players. The creation of a left handed pick model from a right handed model is extremely easy to do with CAD software by using a simple mirror image function. This one step process is shown in FIG. 72 in which a right hand thumb pick (47) is shown on the left side of the mirror (48) and it's mirror image left hand thumb pick (49) is on the opposite side of the mirror. With the combination of the “profile angle”, height and mirror image variations the number of models in this example has increased to twenty four.

The most obvious variation among people is the size of the thumb or finger, for which the size of the pick model would need multiple variations. This function is very common in CAD software and is called scaling. A completed model can be scaled to an infinite number of sizes but in order to ease the choice for our customers we will limit the number to 10. It's interesting to note that this is unheard of in the community of guitar and strummed instrument players. Typically the most is 3 sizes but with this method we have now increased our variations of the original base model to 240 models. A size chart is shown in FIG. 75 in which 10 thumbs of identical shape are arranged in size from smallest to largest.

Of course customers have different playing styles which will require multiple variations of the size, shape, and placement of the pick element on the pick saddle. FIG. 73 shows an example of eight different pick elements for a right handed thumb pick. Pick elements are created as separate 3D CAD surfaces from the saddle and post assembly which makes this variation only a matter of constructing the pick element surface. Eight pick elements factored into each of the 240 models increases the total number of models to 1920.

Thus far the nearly 2000 variations of 3D CAD models for a thumb pick have come through simple modifications of a model constructed from a single thumb surface which has been varied according to the profile angle, thickness, right/left, size, and pick element.

Another way in which thumbs vary depends on the shape of the thumb from just below the base of the nail to the fingertip and can best be demonstrated from a top view. FIG. 74 is an example of six such thumb shapes including the original thumb surface used in the examples up to this point. If we construct a single pick model for each of the five additional thumb surfaces as shown in FIG. 74 the total number of model variations will come to nearly 12000.

But it is not necessary to construct five additional base models of the pick. The method of multiple variations discloses that using a stretch function which is performed simultaneously with a single original thumb and a single pick model built from this thumb is sufficient to produce a totally different thumb with its perfect matching model. The original thumb model and original pick model built for the thumb model are called the base models. When they are used together to perform the variation at the same time with the same CAD function they are called a base model pair.

A screen shot of taken from a computer display within a 3D CAD software environment would look similar to FIG. 100 or FIG. 105. These two drawings show an identical stretch function operating on a foot and shoe model pair. The thumb pick counterpart to this drawing would show a thumb pick model superimposed on a thumb model. A stretch operation produces a different shaped, very realistic thumb model and an identically stretched pick model which fits the stretched thumb as perfectly as the pick base model fit the base thumb model.

This is a critical feature of the method of multiple variations, that model pairs can be created together at the same time using the same CAD function. This concept of creating the variations on both models at the same time is called functionally concurrently. It is named this way and not simply “concurrently” because the same results can be obtained by performing the two separate operations separately using a function on one model of the pair, then at a later time performing the same function and using the same function parameters on the other model of the pair, or performing the same function but reversing the starting and ending points in combination with reversing the direction of the stretch operation. In effect, any combination of functions which produces a result in which the base model pair undergoes a variation which results in a model pair that “fit” together is done functionally concurrently.

The five additional thumb and pick models in FIG. 74 were made in this way. The original base model is the one at the upper left. Between one and three simple stretch functions was performed on both the original thumb and pick models simultaneously to create the additional five pairs of models. For example, the thumb and pick pair to the immediate right of the original was stretched twice in a direction perpendicular to the longitudinal axis to pull in the sides of the thumb and make it slimmer. A visual inspection of the pick model above this thumb shows that the model underwent the same stretch operation and that it does look like it was modeled after the thumb just below it. The third pair of models was stretched in the same direction as the longitudinal axis and was stretched, or in this case compressed, from the thumb tip downward, producing the shortened thumb. Examination of the pick model shows that it appears to have also undergone the same stretch operation.

We now have enough models created through the use of the 3D CAD software to be able to closely approximate the size, shape, and playing preference of nearly every player. This completes the description of the 3^{rd} step of the process of creation of multiple variations of the thumb or finger pick of this invention, that being the creation of multiple variations of a single 3D CAD model.

The 4^{th} step in the method of multiple variations is creating objects from the CAD models described previously using 3d printing. The use of 3d printing in the manufacture of this invention is essential for the method of multiple variations to be a novel way of introducing a variety of choices to the public. Two types of 3d printing technologies currently can be used to produce the picks of this invention. Selective laser sintering uses a fine powder of nylon plastic which is fused together with an infrared laser to produce the object. Another 3d printing method which can be used is extrusion modeling, sometimes called fused deposition modeling in which a fine uniform thread of molten plastic is deposited on successive horizontal layers to build up the part. The materials which can be used to produce the thumb and finger picks of this invention using 3D printing extrusion machines are acrylonitrile butadiene styrene (ABS), nylon, and polyetherimide (Ultem). It must be mentioned that any additive manufacturing technology can be used in combination with the method of multiple variations to produce the thumb and finger picks of which the various models have been described to this point, and that the claims of this invention are not limited to 3d printing by plastic extrusion or selective laser sintering.

Both of these 3d printing methods create parts which require further processing to attain an adequately smooth surface for the pick of this invention. It is not the scope of this specification however to describe the post-build surface treatment necessary to produce a product for sale to the public.

There is a step #5 that must be added to the method of multiple variations in order for users of products created by this method to be able to select one which would be the correct shape, size and preference for style, material, and color. One way in which this selection can be made for a thumb pick is a six step procedure consisting of a series of visual comparisons. A customer is presented with a series of size and shape charts in which thumb profiles of different sizes and shapes are displayed.

In the first step the customer views six thumb shapes as they would be seen from a top or overhead view as in FIG. 74. The customer examines his own thumb and decides which of the six views is the closest match. In the second step are four side views of his first choice from the overhead view, each differing in the profile angle as defined previously. This would look similar to FIG. 68. The customer selects the closest match to his own profile angle. Step three is another side view similar to FIG. 70, in which three thumb shapes are presented, each one of a shape of his first two selections but differing in the thickness or height of the thumb. After making his selection he goes to the size chart and views 10 top view profiles of his top view choice from step 1, the 10 views arranged in order from small to large. Each top view shows a penny placed between the cuticle and the knuckle as shown in FIG. 75. He places a penny on his own thumb or finger as in the chart and compares the size of the penny with his own size and makes his 4^{th} choice. Step S is simply a choice of either right or left thumb or finger. At this point following the 5^{th} selection step he has chosen his closest size and shape from an inventory of 1440 different models.

The last choice is not for correct size or shape but for playing preference. This is a chart similar to FIG. 73 in which he chooses the pick element to match his playing style. With the example of FIG. 73 there are 8 pick elements for thumbs from which to choose, although the number could be expanded to include styles not listed in this specification. Therefore, the total number of models from which he has made his choice is 11,520.

This concludes both the description of the method of multiple variations of 3D CAD models as the method applies to finger picks and thumb picks of this specification, and the description of the improvements to the prior art contoured pick.

### Operation

### Main Embodiment

The improvements to the prior art contoured pick have already been described. The improvements have increased the performance and comfort of the original to such an extent that the improved version is an entirely different device than the original contoured finger pick. The improvement has taken the basic novel concepts of the original and built upon them. The contoured shape of the upper part of the saddle is still retained by the improvement, and now the pick has a totally natural shape which integrates seamlessly with any persons finger or thumb to produce a playing experience that has not existed before now.

It was stated earlier that the improvement replaces the pick flange of the contoured pick with an encroachment surface and a pick element. The improvement creates a more comfortable compression of the lower surface of both the thumb and finger. As described in the specification of the prior art, compression of the lower surface of the pick with the thumb or finger is necessary to keep instrument strings from catching on the lower edge. An underside view of a thumb pick of both the contoured pick and the improvement can be seen in FIGS. 17 and 18 respectively. The contoured pick (FIG. 18) accomplishes the compression with a flat flange which essentially encroaches against the lower surface of the thumb. The problem with this is the compressive force of the flange is not equally distributed across its area of contact with the thumb, with more of the force occurring toward the center of its edge and less at the corners where the flange meets the pick saddle. This is okay for short playing times (30 minutes or less) without causing discomfort. But it's not a natural solution. The encroachment surface of this invention however follows the curvature of the thumb as it gently squeezes the thumb evenly throughout the entire surface of the pick saddle. This even distribution of pressure causes the pick to be much more comfortable and requires less force from the elastic band to get the necessary snug fit required to make the pick work. This is the primary reason for the success of the improved contoured pick, that it distributes the force required to effectively hold it in place over a large area, and distributes more of the force to the less sensitive underside of the finger or thumb.

Replacement of the flange of the contoured pick for the thumb also requires a replacement of the part of the pick saddle which plucks or strums the strings, as the pick flange does this for the contoured pick. The improvement uses a pick element which is essentially a portion of the encroachment surface which has the piece that strikes the strings. The pick element for the thumb can be seen in FIG. 17 with additional views of the construction of the pick element and its integration with the encroachment surface in FIGS. 56-60. Visual comparison of the complete saddle of the improvement with that of the contoured pick can be seen in FIG. 17 and FIG. 18 respectively. Additional comparison of the contoured pick with other views of the improvement in FIGS. 58, 59, and 60 shows the improvement to be much more natural and free flowing, and this is not only in appearance but also in the comfort and playing.

The same design strategy appears in the pick for the fingers, although it takes a different shape because fingers do not have the shape and orientation as thumbs, and are used in a much different way when plucking strings. The finger pick shown in FIGS. 83, 85, 87, and 88 has been formed in the same way as the thumb pick, using a natural finger surface that has been modified with an encroaching undersurface. As stated previously, this gradual squeezing of the finger as the pick saddle extends from the upper surface to the lower surface causes the lower fleshy part of the finger to be pushed snugly against the edge of the pick.

The most obvious difference from the thumb pick is the large open area near the fingertip region on both sides of the finger. This portion of the pick saddle has been removed so that there is no hard material to bump into nearby strings when playing an instrument. If a soft finger does happen to contact an adjacent string it makes much less noise than the hard surface of the pick.

The second most noticeable difference from the thumb pick is the shape of the pick element. The pick element is substantially annular in shape but obviously, not perfectly ring shaped or even perfectly symmetrical. FIGS. 87 and 88 shows the asymmetry of the pick element along the longitudinal axis, the ring being smaller on the right side of the drawings, then larger in diameter and flatter toward the tip and proceeding downward as seen on the left part of the drawing. The larger part of the ring occurs where the string (78) contacts the pick element and is oriented so that the larger curved portion is substantially perpendicular to the path of the string (77) across the surface of the finger and pick element as shown in FIG. 88.

It must be noted that the annular and somewhat oval shape of the pick element and its placement on the underside of the finger is not in itself a new idea. Several existing prior art finger picks have this shape including the ProPik Fingertone, Dadi finger pick, Fred Kelly Freedom pick, and the Alaska Pik. The novel aspect of the pick element of this invention is its asymmetrical geometry. All of the aforementioned prior art fingerpicks are perfectly symmetrical along the longitudinal axis of a finger or thumb.

The asymmetry of both the finger and thumb picks of this invention takes advantage of the dynamics of the way strings move across the lower surface of the finger or thumb. As seen in FIG. 88 the direction of string travel is at a slight angle to the longitudinal axis, and the larger part of the pick element causes this part to protrude slightly above the surrounding surface of the finger so that as the string is plucked it is released from the surface of the pick element instead of the surface of the finger, creating the desired sound. The smaller portion of the pick element not close to the path of the string is partially hidden from contacting any strings because it is pushed into the surrounding finger surface, creating a lower profile.

For a symmetrical shape to accomplish the same thing the direction of the string travel would have to be parallel to the longitudinal axis, which it is not. The only advantage of a symmetrical design of such a pick element is that it can be used for both right and left handed players, where the pick element of this invention requires one asymmetrical model for right handed players and a mirror image of the model for left handed players. And this is entirely possible and practical when combined with the method of multiple variations of 3D CAD models disclosed herein.

A major improvement to the prior art contoured pick is the means of securing the elastic band to the pick saddle. This is important for the band to stay in place on the surface of the saddle and provide the force necessary to hold the pick in place. The post replaces the eyelet featured in the prior art and really transforms the contoured pick into an entirely different device, both in appearance and in performance.

The post is much stronger, and because it is larger than the eyelet it provides a larger area of contact of the band with the edges of the groove and post, and less force is required to hold the band in place. This greatly reduces the possibility of the elastic tearing. Although the post is larger than an eyelet, it has a much lower profile on the upper surface and does not interfere at all with string travel across the saddle on a backstroke. Another advantage is the band is much easier to replace. A new band is simply threaded around the post and it's done. The post also allows the band to be placed further away from the fingertip region which allows a band of much narrower width to be used.

In holding the band securely against the pick saddle the post is subjected to forces exerted by the elastic band which tend to pull the post upward as the saddle and band are held in place on the thumb or finger. To prevent this from happening a key feature of the post is disclosed. This feature is its shape, first as it can be seen from a cross-sectional slice in a front view of the pick as in FIGS. 76 and 78, and second, as it can be seen in a top, or overhead view as in FIGS. 42 and 43. FIG. 76 shows a front view cross-sectional slice near the distal end of the post and at a point where the width of the post reaches its maximum, called the maximum width (51) of the post. FIG. 78 is a close up view of the same showing the post (37) at its maximum width. It can be seen that the cross-sectional shape of the post is somewhat like a trapezoid with rounded corners, and that the distance between the two opposing post longitudinal walls (56) at this cross-sectional slice are nearly the same as the minimum width (50) of the opening created by the opposing post inset longitudinal walls (57) at the top of the inset. When the band is inserted, the larger width of the post plus the thickness of the band itself create a greater width than that of the post inset walls and keep the band from pulling the post upward during use. With the post slightly below the surface the band is held tightly between the walls of the post and inset and also keeps the post out of the way of adjacent strings when playing.

The unique shape of the post can also be seen in FIGS. 42 and 43 where it is apparent that the width of the post along the longitudinal axis is greater near distal end of the post close to the fingertip, reaching the maximum width as shown also in FIG. 42. At the proximal end near the base of the post the reverse is true. The more narrow width of the post near the base allows enough room for the post to be twisted when the band is installed so that the band and post together can be pushed through the narrower opening of the post inset at the distal end. FIGS. 63 through 66 show the installation sequence of the band. The combination of the two shape features of the post, that being the cross-sectional shape and the widening of the post near the fingertip, plus the width of the band itself, all work to keep the band from sliding toward the base of the post while the pick is being used. So the post plus the width of the band is slightly wider than the distance between the post inset walls near the fingertip region and more narrow near the base of the post.

FIG. 81 shows that a number of cross-sectional slices of the post and post inset between the proximal and distal boundaries of the post can be examined to get a better understanding of the shape and why it works so well to hold the elastic band in place. The comparative dimensions of the post walls, inset walls, and band thickness that enable this feature to work well are shown best in FIG. 82 and can be described as follows:

There must exist on the longitudinal axis at least one cross-sectional slice made by a plane perpendicular to the longitudinal axis, the plane passing through both post inset longitudinal walls and through both post longitudinal walls such that the width of the post plus twice the thickness of the band is equal to or greater than the minimum distance between the post inset longitudinal walls. This basically means that at some point on the length of the post, the width of the post with the band in place threaded around the post will be great enough to keep the post from pulling up though the opening created by the post inset longitudinal walls.

The particular cross-sectional slice of the post shown in FIG. 76 and FIG. 78 is made by cutting the pick with a plane that is perpendicular to the longitudinal axis. It's important to note that moving the plane to other points on the longitudinal axis would produce a cross-sectional slice that would show the width of the post to be greater than the width of the opening made by the opposing longitudinal walls of the post inset. This invention, however, requires that the post, band thickness, and post inset width described in the preceding paragraph and shown in FIG. 78 happen only at least one time along the length of the post.

In the earlier description of the improvement it was disclosed that the flexibility (53) of the pick can be controlled by adjustments of the wall thickness (52) of the saddle. A simple illustration is shown in FIG. 77 where it can be seen that the side walls of the pick can flex in or out depending on the finger size and shape. This is an important feature of this invention and adds to the comfort of wearing the device. Most thermoform plastics have some degree of flexibility. These are plastics that exist as solids at room temperature and become soft and formable at higher temperatures. Nylon, ABS, Ultem, acetal (Delrin) and acetal copolymers (Acetron) have all been used successfully in the manufacture of the pick of this invention, and flexibility of the picks constructed of any of these materials can be controlled by varying the wall thickness. Variation of the wall thickness is accomplished during the 3D CAD design stage. Thinner walls make for more flexibility and for this invention, more is better. Increased flexibility not only adds to the comfort of the pick, but also allows a single pick size to fit a much larger range of finger sizes and shapes.

The method of multiple variations of 3D CAD models described in the last section is a good tool in combination with 3D printing to cost effectively manufacture personal, custom fit items which will appeal to the consumer market. This invention is a good example of that. Although many different size and shape combinations can be manufactured during a machine build cycle they can be manufactured quickly and at a low enough cost to make them very reasonably affordable to the general public. Not all consumer items will benefit from this invention. The cost to produce a particular item depends on three main factors—the amount and cost of the material used, the time required for the 3d printer to make the part, and the cost and expense of finishing the surface of the 3d printed part. The improvement of the contoured pick has a main advantage of very low material consumption. The average volume of a thumb pick of this invention is about 0.75 cc. Several 3d printing production facilities are currently available that can produce this pick at a low enough cost to make it reasonably affordable to consumers. Since the pick is so small it is also quickly made with most 3d printers. At the present this invention is the only finger or thumb pick which is produced using 3d printing.

The traditional approach to making many useful devices available to the consumer market at a reasonable price is through the use of injection molding in which a single model is reproduced hundreds of thousands or even millions of times. The injection molding process works extremely well for a large number of identical parts. Many useful consumer items exist that are made using one or more injection molded parts. Injection molding can produce parts that have excellent detail and a glossy surface directly from the machine. It can use a large number of materials having widely differing physical properties, and they can be made very inexpensively in large numbers. But one feature of this method limits its usefulness to items which are in high demand by the consumer market. This feature is the cost and the time to create an injection mold. This limitation of injection molding is perhaps the greatest strength of 3d printing when used with the method of multiple variations.

A single injection mold for a finger pick of this invention would require tooling costs of $5000 or more. In order to produce the variety of picks available to consumers by the method of multiple variations we would need nearly 12,000 injection molds from the examples given previously for only a thumb pick of this invention. It's not hard to see that tooling costs for injection molding would be so high as to render injection molding totally useless as a manufacturing method.

But 3d printing when used with the method of multiple variations does not require that hundreds of thousands of identical parts be produced and sold in order to offset the expense of the tooling required for injection molding. It just requires many single, one-of-a-kind parts. These are parts that do not require multiple injection molds, only multiple CAD models. The dynamics of 3d printing as a manufacturing tool combined with the method of multiple variations allows multiple dissimilar parts to be created together without any tooling at all.

### Description and Operation

### Alternate Embodiments

As was disclosed earlier in the steps to construct the thumb pick one embodiment of the thumb pick does not incorporate a pick element at all. A stringed instrument can be played with just the unmodified pick saddle and a means of securing the saddle to the thumb. An example can be seen in FIG. 37. Most players who use finger picking techniques do not use any aids at all and play with unaided fingers and thumbs. This particular embodiment complements this style and additionally allows the player to use very hard strokes without hurting his thumb.

A second embodiment which may not seem apparent at first is a pick which does not have a means of securing an elastic band to the pick saddle. It is quite possible to use the thumb pick without a post assembly or any other means to hold a band in place. Many rubber compositions, including latex and silicone, have naturally high friction against almost any clean surface. This is why many latex gloves are available pre-powdered. A clean latex or silicone band will cling quite adequately to a clean pick saddle surface of this invention without any other securing means to hold it in place.

One alternate embodiment concerns the pick element of the thumb pick. Most of the upper surface of the pick element is removed as shown in FIGS. 89 and 90, revealing the left upper tip of the thumb for a right handed thumb pick. This elimination of the upper surface of the pick element leaves only the lower striking surface which is very similar to that of a flat pick. This allows the pick element to flex as it contacts a string and causes this plectrum shaped surface to perform even more like a finger held flat pick because it very closely duplicates the dynamics of these plectrums as it is played. It does this because the lower striking surface is not directly connected to the saddle as it was before when the upper striking surface was holding it in place.

The advantages of this fingerpick designed especially for plectrum users is threefold. First, one problem with plectrums is that they are occasionally dropped. This invention eliminates that problem entirely. Second, this invention eliminates the fatigue incurred by players who use plectrums by constantly keeping their thumbs and index fingers pressed together. And the third advantage is that since the index finger is no longer needed to keep a tight grip on a plectrum, it can be freed up to possibly do other things—like eventually trying a fingerpick for the freed up index finger and experimenting with new sounds, rhythms, and playing ability.

Another embodiment of the thumb pick is another modification of the pick element. In FIG. 91 it can be seen that the solid surface of the pick element has been replaced with a shape similar to a ring. This goes even further than the previous embodiment in producing a flexible pick element. Since there is less surface to bend the ring shape bends much more readily. And if still more flexibility is needed the ring shape can be flattened into a narrow strip. A high degree of flexibility allows the pick element to have the flexibility of the thinnest of flat picks.

A third embodiment of the thumb pick is another shape of the pick element. FIG. 92 shows a pick element which departs from the strategy of producing a striking surface which is a thin sheet of material and instead is a wedge shape.

Now an alternate embodiment of the method of multiple variations will be disclosed in which the variations will be performed on something other than 3D models of fingers, thumbs, and the finger and thumb picks created from them. The method of multiple variations of 3d CAD models will be applied to models of human feet and their corresponding footwear. This embodiment will be disclosed in this specification because the process as it has been shown to apply to the construction of multiple shapes and sizes of picking aids for stringed instruments is very similar to the creation of multiple 3D CAD models of shoes of a variety of sizes and shapes.

Several stretching and bending operations were described as part of the process in creating multiple variations of a 3D base model of a finger or thumb and its finger pick. It was also disclosed that a stretching or bending operation was performed on both the thumb model and the pick at the same time, or functionally concurrently, thereby assuring that the resultant contacting surfaces of both would be a close match. The same procedure is performed when creating a shoe model which will also match the foot model from which it was created. This embodiment starts with both a base 3d foot model and a base 3d shoe or footwear model created from the foot model. The creation of the two base models is done basically the same way personalized shoes have been made for more many years.

Most shoes are created using what is called a “last”, which is a foot shaped surface around which the shoe is built. A last is basically a modified foot surface. The thumb pick counterpart for this is the modified thumb surface upon which the thumb pick of this invention is constructed. A typical shoe last with the foot from which it was made is shown in FIG. 93. The last keeps only the basic shape of the foot and eliminates the toe details and many of the bumps on the surface of a natural foot. Most lasts are also modified to be a little longer at the toe and some are modified to include fashion features such as a box toe or a pointed toe. Lasts are also usually raised vertically a little at the toe to create “spring” and at the heel to accommodate the heel of the shoe. Also ladies high heel shoes will have a pronounced “tip toe” bend at the ball joint. Every custom made shoe will be constructed from a last which is tailored from a customers foot. Therefore each custom shoe can be associated with its custom last and the customers foot. These three items can be linked together as separate items and their data stored in a computer database. The form in which the data would be stored would be the 3D CAD model of the final shoe, the 3D CAD model of the custom last, and the 3D CAD model of the customers foot. This is an important foundation upon which to build the link to the method of multiple variations of 3D CAD models previously described.

With the exception of ladies high heels and other shoes in which the heel is substantially raised the method of multiple variations can be performed in the same way as thumb and pick variations are made. This is with the pick model superimposed on the thumb model within the modeling program and the deformation functions applied concurrently to both models. So in most cases of footwear, with the noted exception, a foot model and its associated footwear model can be modified concurrently, without an intermediate reference to the last.

The question is where to start with the reforming operations. A study of the way in which shoe lasts are created reveals useful information on the critical points of measurement when creating custom lasts. A comprehensive guide to traditional shoemaking is “The Manufacture of Boots and Shoes”, edited by Frank Golding and updated from a book first published in 1867. A detailed section on creating a shoe last describes critical measurements in which points at the ball joint, the instep, and heel are taken in addition to the usual length and width. The first three measurements also include girth, or circumference measurements. FIG. 94 and FIG. 95 show a top view foot trace and a side profile of a foot indicating the approximate positions of the traditional reference points of these three. This also gives a clue as to where variations in foot shapes originate. The side profile of FIG. 95 shows the lateral, or outside of the foot, location of the ball joint, instep, and heel reference points while the top view shows both the lateral and medial, or inside of the foot, positions of the girth measurements of these three. It should be noted that the majority of foot measurements within the shoemaking industry, with the exception of overall length and width, are not standardized. Each shoe manufacturer seems to have its own standard and even interne searches of shoe measurements show varying ways in which the measurements have been made.

A novel concept will be introduced which uses easily definable reference points on a 3D CAD model to help more accurately define the stretching functions used to create the many variations of the 3D CAD models of feet and shoes of this specification. These nodes, or reference points, can be used to define the axes upon which 3D model variations will be performed. Many of the nodes to be defined herein have as their counterparts the specific points on a foot or shoe last which were previously discussed, that have been used as reference points for years in traditional shoe making. Basically this invention uses them in a different way, that is, not to create shoe lasts and ultimately shoes, but as starting points of variations to be performed on a base foot/shoe 3D CAD model pair, a multiplicity of variations subsequently creating an inventory of 3D models of feet and their accompanying shoes.

In addition to the use of a node to define the position and length of a reference line, or axis, a node in this specification can also be a specific point on a 3D model at which a variation originates. Usually a combination of nodes is needed to define a particular stretch operation. For example, a simple stretch of a foot and shoe model combination along the direction of a longitudinal axis would involve the definition of the starting and ending points of the area to be stretched. Both these points would be nodes, or easily definable reference points. Another way to look at nodes is to consider them as reference points within a three dimensional coordinate system compared to their counterpart reference points that originate from two dimensional projections of the foot, shoe last, and shoe.

The concept of using an easily definable reference point is not only to enable a CAD modeling person to consistently identify the correct reference points, but also to enable computer software algorithms to eventually do the same. It was stated earlier in this specification that although a human operator with 3D CAD skills can perform the stretching operations manually and create the inventory of multiple variations of the models, the ultimate embodiment of this method would be the integration of most of these functions into a scripted programming environment and performed automatically by software with very minimal human intervention. Most of the major 3D CAD modeling software programs support scripted programming, typically in the form of object oriented scripting, which allows the CAD modeling person to write his own computer programs for the purpose of tying together many functions that, in the beginning, are performed manually, one at a time. Now we will define the nodes to be used in the various stretching operations disclosed herein and discuss their origins.

In both traditional shoemaking and shoemaking by mass production techniques the two most important measurements of feet are the length and width. The length measurement only requires a longitudinal axis. An accurate measurement can be made of the foot length without this axis but the creation of shoe lasts requires such an axis as a reference point for subsequent measurements. The longitudinal axis of a foot has commonly been drawn with its proximal end at the furthest point on the heel and passing through a point at the center of the 2^{nd} toe. That is where our first two nodes will be defined. The foot length is the distance between two parallel lines, both perpendicular to the longitudinal axis, one line passing through the distal maximum of the foot and the other passing through the proximal maximum at the heel as seen in FIG. 94.

In FIG. 97 it can be seen that the proximal node and distal node of this axis have been located in three dimensional space instead of a two dimension foot trace, above the two dimensional plane of a paper trace of the foot, occurring at the three dimensional maxima of the front and rear of the foot.

The second most important measurement of a foot for a correct shoe size is the width. The maximum foot width occurs at the ball joint where the metatarsal bones of the foot join with the proximal phalanges. This is easy to locate by referring to an overhead view of the foot as in FIG. 96. In this view a right foot has been traced in the same way as has been done in shoemaking for many years. On the left side of the drawing near the distal end of the foot is a bump which will define the first node. This makes a convenient reference point because it has a clearly definable maximum and will be called the joint 1 node (94). FIG. 97 shows that this node is also located above the plane of a paper trace of the foot.

A point on the outside of this right foot clearly indicates a similar bump, and a point will be located at this maximum and be called the joint 5 node (95). These nodes are the result of the underlying bone structure of the foot and make convenient reference points because every foot has these features and they are easily located. Foot width has traditionally been determined by the measuring the distance between lines parallel to the longitudinal axis, one line passing through the lateral maximum of the foot at the joint 5 node and the other line passing through the medial maximum at the joint 1 node. The width line (99) is shown in FIG. 96.

An additional node will also be defined which will be the joint center node (101), which is found by drawing a line between the joint 1 and joint 5 nodes. This line is the joint line (100). The joint center node is found at the intersection of the joint line and the foot longitudinal axis as seen in FIG. 96.

Another important three dimensional reference object will be defined now. This will be called the horizontal plane of the foot, and has as its counterpart the plane of the paper trace, however the horizontal plane will be defined by three nodes, these nodes being the proximal and distal nodes of the foot, and the newly defined joint 1 node. FIG. 107 shows a view of a left foot from a distal and medial position. In this drawing the horizontal plane is shown bisecting the foot and passing through the three nodes that define this plane. This curve will be called the horizontal foot profile curve (102). It can be seen in FIG. 107 that the joint 1 node is located on the horizontal foot profile curve because this is one of the three points used to construct the horizontal plane. This node is at the medial maximum of the foot model. The lateral maximum on this curve on the other side of foot longitudinal axis is the joint 5 node.

Now the process of constructing variations of the foot model and it's corresponding shoe model will be discussed. It was mentioned previously that most shoes available for sale to the public vary only by length for a particular model. Some stores also have models available in limited widths for the same length. We can start constructing foot and shoe model combinations according to these two dimensions, length and width, being only concerned at this point about creating varying shapes instead of creating specific lengths and widths. A standard foot model and a shoe model that has been constructed to fit the foot model will be the base model pair and are shown in FIG. 98. A single left foot model and a corresponding left shoe model are shown in this drawing.

At this point the concept of the functional surface introduced earlier with thumb picks and finger picks will be revisited in a different form in the construction of variations of shoe models with the method of multiple variations. It was stated earlier that this term links together three models that are typically constructed in the manufacture of the picks of this specification. These are the original thumb surface, the modified thumb surface, and the final thumb pick made using the modified thumb surface. The foot/shoe equivalent of this is the original foot model, the modified foot model usually called the shoe last, and the shoe made using the shoe last as a template for the interior surface of the shoe. In the same way that the modified thumb surface is the functional surface of the thumb from which it is made, the shoe last is the functional surface of the foot from which it is made.

A notable deviation in the entire process of constructing the pick from the original thumb surface will be examined here. The process of making a thumb pick which would serve as the base model for the method of multiple variations included the construction of a modified thumb model, although the modified thumb model was not used at all to make the variations. Instead the original thumb model was used in combination with the final thumb pick to serve as the base model pair for the method of multiple variations. Although the modified model was required to construct the pick base model it is not required to construct the variations of the base models.

This will also apply to the construction of an inventory of foot/shoe model pairs using the method of multiple variations. But a link to the shoe last, or modified foot will remain to be used, and that is the term functional surface. The functional surface of the foot model of a perfectly matched foot/shoe model pair would be the surface of the shoe last of the resultant foot/shoe model pair. But the term exists as a useful tool to express the perfect match of a foot/shoe model variation constructed by this method.

The first variation considered will be one which varies the width to length ratio of the foot. The width to length ratio will be considered to be the primary differentiator of the shape of feet and shoes, since those two dimensions are the only differentiating parameters for the majority of shoes manufactured. So a width/length function which varies the shape of a foot/shoe combination will be the first operation to change the shape of a base model pair. There are a number of ways to change the width/length ration, but the first example will change the width only of the base model pair. This can be done with a simple one dimensional stretch operation that begins as shown in FIG. 99 with the two models superimposed within the CAD modeling program, the shoe model superimposed on the foot model just as it would be worn. In FIG. 100 a simple stretch function is invoked and parameters set to perform a stretch perpendicular to the longitudinal axis along the entire length of the foot and shoe models. The bold arrows pointing away from the longitudinal axis indicate the direction and relative magnitude of the stretch along the length of that axis, and that the degree of stretch is constant along the entire length of both models.

FIG. 101 shows separate outlines of the foot and shoe before and following the stretch, with the broken line in both drawings showing the original outlines. Three observations can be made. The first is that the degree of stretch appears to be consistent from one side of the longitudinal axis to the other. The second is that very little stretching occurred in the direction of the longitudinal axis. This is apparent upon examination of the outlines at the proximal and distal nodes. The third thing is that the amount of stretch at any particular point along any of the outlines appears to be proportional to the distance of the point from the longitudinal axis. For example, the deviation of a point on a stretched outline near either node of the longitudinal axis is smaller than a point further from one of these nodes.

FIG. 102 shows both the stretched foot model and it's concurrently stretched shoe model. FIG. 103 is a foot and shoe model stretched twice the distance of FIG. 102, and FIG. 104 shows a model pair stretched the same distance as FIG. 102, but inwardly toward the longitudinal axis, making both models narrower. These four simple stretches of base foot and shoe models has produced four pairs of foot/shoe models, the feet of each pair differing only in the width, and the same for the shoes, each shoe a perfect fit to its foot.

One aspect of the variation of the models by width/length ratio is that it can be done by varying the width as in the preceding example, or it can also be done by varying the length of the models. Instead of stretching the foot/shoe pair perpendicular to the foot longitudinal axis as in FIG. 100, the operation can be done along, or parallel to the foot longitudinal axis as shown in FIG. 105, in which the base foot/shoe model pair used previously is shown similar to FIG. 100. The result of varying the length instead of the width produces comparatively the same results. In FIG. 105 the double arrow vertical lines at the distal end of the models indicate that the majority of the stretch will be done at this end while the part of the models near the proximal end will remain relatively unstretched.

The result of a stretch away from the proximal node a nominal distance produces a model pair similar to the first pair shown in FIG. 106, at the left side of the drawing. Two additional model pairs are shown as the 3^{rd} and 4^{th} pairs from the left in FIG. 106, in which the stretch was toward the proximal node producing shorter foot and shoe models. The second model pair in this drawing is the base model pair which have not been stretched and shown as a comparative reference for the other three model pairs. Additional stretches can be performed in both directions but for the sake of brevity these are not shown. Also not shown are a set of model pairs stretched by holding the model constant at the distal node and stretching the area at the proximal node.

An advantage of using length instead of width stretches to produce the variations in width/length ratios, is that the stretch can be more controlled and incrementally varied with the use of an additional node, or reference point in three dimensional space. Now this additional node will be described.

A traditional measurement in shoemaking is the instep, which is another somewhat ambiguous entity when it comes to shoemaking since there doesn't seem to be a standard for this. It begins with a bump on the top of the foot which is used as the upper reference point. This is not too difficult to locate and is shown in FIG. 97. The ambiguity occurs when locating the lower reference point and there exists no explicit procedure for doing this. Most shoemakers take a girth, or circumference measurement while traditional custom shoemaking also included a simple height measurement from the upper reference point to some point below on the undersurface of the foot as shown in FIG. 95. For the purpose of constructing easily and consistently locatable nodes that will be used to create foot and shoe model variations this specification will define two instep nodes—the upper instep node (97) and the lower instep node (96). It should be mentioned that as with other nodes named in this specification these are reference points defined in three dimensional space rather than upon a horizontal paper trace of the foot or a two dimensional side profile traditionally used by makers of custom shoes.

The upper instep node is very similar to the two dimensional counterpart and can be best understood by referring to FIGS. 107 and 108. The curve extending from the front and top of the foot running parallel to the longitudinal axis is the vertical profile curve (103). It is the result of an intersection of a vertical plane perpendicular to and passing through the longitudinal axis with the foot model. The upper instep node is located on this curve at the top of the bump on the top of the foot.

The lower instep node will be found by finding a suitable position on the lower part of the foot to measure the instep girth. This is done first by creating a line perpendicular to the longitudinal axis and passing through the upper instep node. This line is called the instep axis (104) and is shown in FIGS. 108 and 109. A vertical plane called the instep vertical plane (105) is defined by extending the instep axis downward in a line perpendicular to the longitudinal axis, passing through the longitudinal axis and continuing past the lower surface of the foot model. An intersection is made with the instep vertical plane and the foot model which results in a closed cross-sectional curve shown in FIG. 110. This curve is called the instep vertical curve (106).

Then the instep vertical plane is rotated on the instep axis a few degrees so that the lower edge of the instep vertical plane moves closer to the proximal node. A second intersection is made resulting in a 2^{nd} closed cross-sectional curve, then the process is repeated until several closed curves are formed as shown in FIG. 110. The instep girth curve (107) is simply defined as the closed curve with the shortest length. This curve is shown in FIG. 110 as the curve drawn with the broken line. The lower instep node is then found by referring to the plane which formed the instep girth, called the instep plane (108) shown in FIG. 109, and defining the lower instep node as the point of intersection of this plane with the longitudinal axis as shown in FIG. 109. It can be seen in FIGS. 108, 109, and 97 that the position of the lower instep node is the approximate center of the foot model.

It's useful to define the instep position in this way because it's easily located and makes it possible to create software algorithms which can locate these nodes consistently. That is possibly the main reason why the smallest closed curve was selected, because it represents a minimum value among a progression of values moving in one direction, reaching a maximum or minimum, then moving in the opposite direction. It was also selected because it is probably the same way shoemakers have made their instep measurements for years. The choice of where to measure basically comes down to the progressive shape of the foot from the heel to the toes. There is an observable narrowing near the longitudinal center of the foot and it has been to the advantage of the shoemaker to select the measurement where the smallest circumference occurs, and this has, apparently, been done by experienced approximations that started with guessing.

At this point two additional nodes and two closed cross-sectional curves will be defined which will not be used specifically to create additional model variations, but for a purpose to be disclosed later in the specification. The two nodes are the upper heel node (109) and lower heel node (110), and the closed cross-sectional curves are the heel girth curve (113) and the joint girth curve (114). These two nodes and two closed cross-sectional curves are shown in FIG. 124.

The location of the upper and lower heel nodes are shown by referring to FIG. 95 which is a drawing based on a similar one from a book on traditional shoemaking. It shows a heel line (90), the upper end being located at the top proximal part of the foot where the curvature of the foot to the ankle is greatest. The lower end of the heel line would be close to the proximal node and is located at the point of curvature where the lower horizontal surface of the foot turns upward toward the ankle. The 3D counterpart nodes are found similarly but are located on the vertical profile curve of the foot as shown in FIG. 124.

The heel girth curve is found first by constructing a vertical plane similar to the instep vertical plane of FIG. 109, except the plane will originate from the upper heel node. Then the lower horizontal surface of the plane will be rotated in the direction of the lower heel node until it intersects this node as shown in FIG. 124. At this point the plane just constructed is called the heel girth plane (111) and its intersection with the surface of the foot model produces the heel girth curve.

The joint girth curve is found by creating a vertical plane passing through the joint 5 node and the joint 1 node. The plane is called the joint girth plane (112) and its intersection with the surface of the foot model produces the joint girth curve. These are also shown in FIG. 124.

It's important to disclose that the exact position of nodes is not critical to the method of multiple variations of CAD models. For example, the placement of the proximal node as shown in the preceding examples has been at the most proximal point on the heel of the foot model. It could have been placed at the most proximal point of the shoe model or even extended past the surfaces of both models and the stretch function performed to generate variations that are just as functionally equivalent. The use of nodes as reference points attempts to mimic the underlying skeletal structure which has a direct consequence on the exterior shape of an anatomical part. When used in the context of the method of multiple variations of CAD models the author recognizes that natural variations in shapes of anatomical parts among different people can be largely attributed to the distance between skeletal joints and the relative size and position of joints with respect to adjacent joints.

For example, the lower and upper instep nodes have as their basis the structure of the tarsal area of the foot and the joint of the tarsal with the metatarsal area. This part of the foot appears to be the center both structurally and functionally with respect to the distribution of pressure in movement. It appears that foot shape variations among individuals is largely due to the shape and length of the foot distal to the instep area in proportion to the shape and length of the foot proximal to the instep. So this is where the remainder of the stretching operations which determine the width/length ratio will originate, that is, from the distal, proximal, and the lower instep node. It's it important to keep in mind that these nodes should only be considered as distinct points only by definition, and that functionally they are to be considered as regions or areas.

Now that the lower instep node has been defined a stretching operation can be described which uses this node in combination with the proximal and distal nodes to perform stretches and compressions along the longitudinal axis. The following set of width/length stretch operations will use the lower inset node in addition to the proximal and distal nodes. The three nodes are mostly in alignment with the lower inset node being approximately in the center as shown as shown previously.

FIG. 111 in the upper left corner shows a base foot/shoe model combination superimposed as shown previously with a rectangular area enclosing the distal half of the models. This part of the model will be the part that is stretched. The rectangular area is bounded by two horizontal lines and two vertical lines. The lower horizontal line lies on or substantially near the horizontal plane and passes through or substantially near the lower instep node shown in the drawing. The upper horizontal line is close to the distal node, although it could be located more proximally or distally. The left and right vertical lines enclose the model on those two vertical boundaries. The arrows pointing up and down on the upper horizontal line indicate that most of the stretching will occur at the distal end of the model while the area close to but distal to the lower instep node will remain relatively unstretched.

The three model pairs shown separately to the right of the base models are three resultant model pairs of three stretch operations. The first model pair to the right of the base models has been stretched to produce a longer pair of models while the remaining two pairs have been stretched toward the heel producing shorter models. Two important observations can be made from this stretching operation. First, the portion which is lower, or proximal to the lower instep node of both models has remained entirely unstretched. The only variation at all from the base models occurs above the lower instep node. The other observation is that all three of the newly created model pairs have exactly the same width. This is a great advantage over the stretch operations shown previously in two ways. First, it allows a much higher level of control over what happens when the function is performed and facilitates the creation of models where the sizes can be incrementally varied. Second, the nature of the variation itself, occurring at the lower instep juncture, would more accurately approximate natural variations of feet which would originate at or near the instep joint and its positional relationship with the heel and joint areas.

Another variation of stretching operations using the lower instep node is similar to that of FIG. 111 but causes the variations to occur in the area between the heel and lower instep nodes as shown in FIG. 112. This drawing depicts the same base model pair and three pairs of subsequent stretches but the stretched area is the lower, or proximal part of the models. It has been found that a greater number of model variations which resemble realistic feet can be created using this approach than the one of FIG. 111, possibly because most variations among feet occur due to variations in the proximal part of the foot. Only three variations are shown, although many realistic combinations are possible. As in the stretching operation shown in FIG. 111, these stretches are much more controlled, with the stretching occurring only within the bounded area shown and none occurring above the lower instep node.

One other method of creating foot/shoe model variations in which the variation is in the width/length ratio will be disclosed. It uses a variation of a simple stretch function in which the degree of stretch perpendicular to an axis varies along the length of the axis to produce a tapering effect. FIG. 113 shows how this works. In this drawing the same base foot/shoe model pair appears superimposed within the 3D CAD environment and the area to be stretched is bounded by a rectangle. The upper and lower horizontal lines of the rectangle pass through or near to the distal and proximal nodes, and the left and right borders are the broken vertical lines closest to the foot longitudinal axis. The horizontal arrows indicate the direction and magnitude of the stretch and show that the portion of the models near the proximal end of the model will be stretched just a little while the part near the distal end will be stretched the most, and that the degree of stretch varies linearly from one end of the axis to the other. Although the arrows point away from the longitudinal axis indicating that the distal portion of the models would be expanded more than the proximal portion, they could just as well point toward the longitudinal axis, which would effect a narrowing of the model from the proximal to the distal end.

FIG. 114 shows the result of an expansive stretch on the foot and shoe model examined separately. The broken line in both the foot and shoe outlines indicates the base model while the solid outline is of the resulting stretch. It can be seen by examining the before and after lines that both models appear to have been stretched to a tapering effect as the degree of stretch progresses smoothly from the proximal to the distal portion. FIG. 115 is an overhead view of the outlines of FIG. 114 and FIG. 116 is the result of a tapered stretch in the same direction and approximately twice that of FIG. 115. FIG. 117 is the result of the tapered stretch which stretches the model toward instead of away from the foot longitudinal axis.

Several important observations can be made about the tapered stretch of these examples. One observation would include a comparison of the width stretch function shown in FIG. 101 to a similar view of FIG. 114. Both functions changed only the width of the models, but a close comparison of the two drawings shows that the operation of FIG. 101 increased the width about the same along the entire length of the foot longitudinal axis, the only apparent deviation from this as the outline of the model approaches the longitudinal axis, and becomes proportionately smaller. The tapering stretch of FIG. 114 shows that the amount of the stretch at any point along the axis not only increases as the outline of the model becomes further away from the longitudinal axis, but also it increases gradually from the proximal node to the distal node.

Another observation is that all of the models in the tapering stretch examples just shown did not change at all in the length of the model, only in the width. The practical application of the tapering function in this way is to create models which can be varied solely by the width at the joint, or distal area of the foot and shoe. This is useful because some people have feet narrow at the heel but overall are comparatively wide due to a greater spreading at the joint. Others have a maximum width that is comparatively narrow considering the width of the heel. So it makes sense to incorporate a stretching operation in which a single variation will be the width at the joint.

Variation of the width of the heel alone is the last width/length variation to be disclosed.

Another way in which feet vary is the vertical height and is usually measured at the instep which typically defines this parameter. Either a tapering stretch function or a simple stretch function can be applied in the direction of the line between the two instep nodes. FIGS. 118 and 119 shows a side view of a base foot model and a its shoe model and FIG. 120 is a composite view of both as they would appear on the display screen of a 3D CAD modeling environment. The particular stretch function chosen for this example is a tapering function with the base node located at or near the center joint node and the end of the area to be stretched at some point near the proximal node. It should be mentioned again that there are a large number of ways in which any particular stretch result can be obtained, most of them depending on the nodes selected and the part of the model to be stretched. The example shown in FIG. 120 is one of many possible embodiments to get the results shown.

The example of FIG. 120 indicates that the area to be stretched is most of the foot and shoe model lying between the center joint node and the heel, or proximal end of the models. The bounding area for the stretch is the rectangle defined by two horizontal dashed lines lying parallel to the foot longitudinal axis and on either vertical side of it, and vertical lines extending upward and downward originating from the center joint node and the proximal node. The vertical arrows originating from the horizontal bounding lines indicate that the degree of stretch near the center joint node will be smaller than the amount of stretch occurring closer to the proximal node, varying linearly from node to node. All four arrows shown point away from the longitudinal axis which means that the models will be expanded in the direction of the arrows. It will be mentioned again, that the arrows could have been shown to be in the opposite direction, pointing toward the longitudinal axis which would mean that the model pair would undergo a contraction. For clarity of the drawing the additional arrows were omitted.

FIGS. 121 and 122 are the results of the first stretch of the models to vary the vertical height, or instep. In this case the models were expanded and can be observed by comparing these two models to the same view of the base models in FIGS. 118 and 119. FIG. 123 shows a model pair which underwent a contraction of the instep producing much flatter foot and shoe models. Both of the examples shown which produced the instep variations are extreme examples. In other words there are probably not many feet with a higher instep than FIG. 118 or lower than FIG. 123. One conclusion is that there are a much larger number of instep variations that are shown in this example which could be applied to the method of multiple variations.

At this point we could consider the effect of the previous stretching operations on the number of models that have been created. A number of functions were demonstrated that vary the width/length ratio, but we will select the combination that varied the proximal and distal areas separately with the use of the lower instep node. If, for example, four model shapes were created by varying the distal portion of a base/foot model pair, and six additional model shapes were created by varying the proximal portion, then 10 models representing the entire range of width/length variations are the result. For purposes of correct terminology any models or model pairs created by the first set of variations of a base model pair using the initial set of variation functions will be called 1^{st} set of variations.

The function used to vary the width of the joint area of the foot obviously can create an infinite number of variations depending on how small an increment is desired. For convenience the number of discreet widths available with the use of the Brannock measuring device will be considered. This device can measure nine widths, each differing by 3/16 of an inch. With the use of the tapering function the base foot model with its accompanying shoe can be stretched eight times to create a total of nine foot models and nine shoe models, each model differing from another model by only the joint width. If each of the 10 models produced by the width/length variations are used as base models for 9 different joint widths, then a total of 90 model variations have been created. These model pairs were created as a successive combination( ) of each of the 10 1^{st} set of variations of the previous example with a 2^{nd} set of variations functions, and are called the 2^{nd} set of variations.

At this time a new term will be introduced which will be vital to the concept of the method of multiple variations of 3D CAD models. The term is “successive combination” and refers to the process of building an inventory of models by creating a 1^{st} set of variations from the original base model pair using an initial CAD function, then building upon the newly created 1^{st} set plus the original base set using a 2^{nd} CAD function to create a larger number of 2^{nd} set of variations. This is successive combination and is the primary reason why a large diversity of sizes and shapes of 3D CAD models can be created, often by using simple one or two step 3D CAD functions.

Variations in the instep height will produce another group of models. The models shown in FIGS. 118 through 123 represent only three variations in this parameter. If the Brannock measuring device can measure 9 distinct and useful foot widths we could reasonably assume that an equal number of instep heights would be appropriate to cover the range of most foot shapes. If each of the 90 models produced by the previous two combinations of variations are used as base models for 9 different instep sizes, then the total number of models comes to 810. These additional models were produced by a successive combination of the 2^{nd} level variations with a 3^{rd} CAD function so they are called 3^{rd} level variations.

The 810 models produced thus far have no specific dimensions and vary only in the relative shape of the models. At this point if the number of shapes is sufficient then a scale function would be appropriate to scale each of the 810 shapes to specific dimensions in a way that the size increments more precisely between adjacent variations. A practical way to do this would be to use a scale parameter which would produce constant increments in the length of the model pairs. For example, several foot sizing standards have more than 50 different sizes for adults and children combined including half sizes. The parameters for the scaling are set to produce a constant increment in size, of say, 3/16 inch which is half a shoe size, for each of the 810 different model pairs created through the last example. This would produce a total inventory of over 40,500 shoe models, each one a different size and shape but incremented in the scaling step to produce constant variations in length which match industry standards.

In the same way that thumb picks and finger picks of this invention exist for both right and left handed players, the shoe models of this invention must exist for both right and left feet. The examples to this point have disclosed a method to produce 40,000 plus shoe models. But the models produced heretofore have been created using only one base foot model with its accompanying base shoe model. We need a shoe for the other foot.

Fortunately with 3D CAD modeling the additional 40,000 models don't have to be created in the same way the original 40,000 were made. A simple mirror image function applied to each of the 40,000 originals will increase the total number to 80,000. An additional advantage of 3D CAD modeling is the fact that most commercial 3D CAD modeling programs provide scripted programming support. This means that the CAD modeling person can create a simple list of the CAD models, provide the necessary mirror imaging parameters such as the mirror plane, and create a simple function which will run the steps of the mirror procedure on the first model in the list, save the newly created model, then loop back to the beginning of the procedure and increment the pointer to the next model in the list. Thus the additional 40,000 models can be created in a few hours with no additional human intervention.

As before it's important to note that in the example provided these nearly 40,000 additional models were created by successive combination of 3rd level variations with a 4^{th} CAD function to produce the 4^{th} set of variations. It's important to note that model variations don't have to be done in the same order as the examples provided up to this point. Any particular model variation previously described doesn't have a level variation assigned to it as part of its identification, but the level variation only applies to where the variation occurs in the particular sequence of variations that are used to produce the final result, which is a large inventory of diverse model shapes and sizes.

Up to this point the application of the method of multiple variations of 3D CAD models as it is applied to feet and footwear has been done with shoe models where the shoe is considered a single CAD model. If such a model were manufactured by 3d printing, the result would be a shoe which would be entirely constructed of a single material, most likely also a single color. The obvious conclusion is the practical usefulness of such a shoe other than the fact that it fits phenomenally well would be limited. Most 3D CAD shoe models exist as separate unattached parts so that the parts can be manufactured in different ways resulting in a much more practical end product. Consider, for example, shoe parts comprising the sole (insole, midsole, outsole), heel, upper, tongue, lining, toe cushion, and upper embellishments. In the first alternate embodiment of this method each shoe model created is created as an entire shoe model, while another embodiment creates the shoe model as its separate parts.

In this latter embodiment a huge advantage is the manufacturing of the individual parts by separate 3d printing processes. For example, a sole and an upper can be manufactured using different 3d printers or during separate build processes so that the color or composition of the parts can be varied. The same procedure can be applied to every separated part, or groups of parts. Soft parts such as linings and insole cushions can be manufactured by a 3d printing machine capable of manufacturing soft, springy parts, while the sole and heel can be produced using tough materials such as nylon or polyvinyl chloride. The upper can be 3d printed separately with a tough and flexible material like nylon in a different color or dyed to a different color than the sole before it is attached to the sole. The result of this latter embodiment is a shoe that not only exactly fits the contours of the foot, but also looks and performs the same as products found in consumer shoe stores.

Now that a large inventory of foot/shoe model combinations has been created, there remains the disclosure of a process in which a customer will be able to select the closest size and shape from among such a large combination of sizes and shapes. The method of multiple variations would be very limited in its application if there were not a way to match a customers feet with the appropriate model matching his feet among the inventory of over 80,000.

A simple rudimentary procedure will be used. The procedure uses a computer database to store critical parameters of each foot/shoe model pair. Such a database would store at least the following critical parameters:

Length of the foot model

Width of the foot model as typically measured in the shoe industry and this specification

Joint girth determined as the length of the joint girth curve

Instep girth as previously determined in this specification

Heel girth determined as the length of the heel girth curve

Three dimensional coordinates of the following nodes using a single node to normalize the coordinates of the other nodes, the coordinate values in the same units used to define the length and width
Distal node
Proximal node
Joint 1 node
Joint 5 node
Center joint node
Upper instep node
Lower instep node
Upper heel node
Lower heel node

In addition to the critical parameters listed above the database could also store two dimensional graphical displays of both the side profile and an overhead view of the foot model, and one or more screen displays of the foot model as it appears in a 3D CAD modeling environment.

The selection process uses a simple database search by the customer in which the customer enters his foot length, width, instep girth, and optionally his heel girth. Instructions for determining these are the basically very similar to the procedures used in this specification to locate the nodes used to determine these measurements and are provided to the customer prior to the database search.

The search could be done a number of ways, but a simple way is to first search the database records for length within, for example, 3/16 in. which is half a shoe size. Then the matching records would be searched for width in the same way, narrowing the remaining matched items to the correct length and width. The search is continued by restricting those records to the ones within the target instep girth, followed by another sequential search of those results for heel girth within the 3/16 in. target range.

The quality of the results obtained obviously depends on the number of models that exist in the database and the number of ways and degrees in which they have been stretched or tapered. It's quite possible that a suitable match cannot be found in which case the customer decides that either he can broaden the target range of a particular parameter such as instep girth, or possibly eliminate heel girth and/or instep girth.

### CONCLUSION

The contoured pick was created originally to solve age old problems with traditional plucking/strumming aids that are worn upon the finger or thumb. The main problems for many years had been discomfort, clumsy, noisy, and unnatural feeling of all existing products. The contoured pick, with a novel design that capitalized on the natural shape and strategic placement of the striking edge, or pick flange, changed the paradigm for such strumming aids. The current invention, being an improvement upon the contoured pick, refines and builds upon the novel features of the contoured pick and transforms the shape and performance into something the author calls a “bionic” device because of the way the improved contoured pick feels and performs, as it feels like a natural extension of a finger or thumb.

The changes in the improved contoured pick have come about largely because of the way it is now designed and manufactured. This has already been described in this specification, and is called the “method of multiple variations of 3D CAD models” or the “method of multiple variations”. The method of multiple variations uses a unique combination of three new “3D” technologies, all of which have been in existence only within the last 20 years or so. These three technologies are 3D scanning, 3D CAD modeling, and 3D printing.

With 3d laser scanning we are able to rapidly accumulate a small inventory of surface contours. With these surface contours we are then able to a large inventory of 3d CAD models of our “bionic” pick, each pick modeled from an actual thumb or finger surface. The 3D CAD software allows us to create an infinite number of shapes and sizes from a single natural surface—all at the touch of a mouse. It also allows us to create left and right hand models in the same way. We can also vary the pick element placement, size, and style by a few simple mouse clicks using 3D CAD software. There exists already a multitude of virtual CAD models of our “bionic” picks of different sizes, shapes and having different pick elements.

The unique method of constructing multiple variations of shapes of the 3D CAD models for the finger and thumb picks described herein is applicable to other personal items that are made to be worn on a persons body. An embodiment of the method of multiple variations has been described in which shoes and other footwear can be produced as “custom fit” items by creating multiple variations of 3D CAD models of these items, followed by the manufacture of these items by 3d printing, also known as additive manufacturing.

3D printing has two unique advantages in the making of objects; (1) the ability to manufacture dissimilar parts at the same time, and (2) the complexity of parts that can be made. Although 3d printing has been in existence for over 25 years, it has only been very recently that this technology has advanced to using materials that are extremely durable and inexpensive—durable enough so that both the improved contoured pick and consumer footwear items can withstand intense everyday use, and cheaply enough both of these items can compete in price with existing products produced by other methods.

This unique combination of 3D technologies with the method of multiple variations will enable a paradigm shift in the way everyday objects are created and made available to the public. Familiar products can be created in ways which were not possible just 5 years ago. More people are beginning to use 3D CAD software to create virtual models of physical objects. Three dimensional scanning is being used to acquire surfaces of familiar objects which can be altered by creative people using 3D CAD software into objects which have not existed until this time. 3D printing makes possible the manufacture of any object that can be expressed as a three dimensional computer model. The combination of these three recent 3D technologies with the method of multiple variations has now made a way for useful consumer goods to be produced by individuals working alone or in small numbers without having to invest heavily in production equipment, specialized tooling, and even without incurring ex-pensive prototype design and manufacturing.

Anyone reading current technology news is aware that people in the business expect the new existing “3D” technologies to lead to a breakthrough in production of personalized custom products for the consumer marketplace. They are waiting for a “link” to tie these together so that many customized and personal products of everyday use can be made and be available to any and every person. The method of multiple variations creates the link.

### DRAWING FIGURES

FIG. 1 Top view of prior art “contoured pick” thumb pick with band.

FIG. 2 Top view of thumb pick of this invention with band.

FIG. 3 Same as FIG. 1 except the band has been omitted for clarity.

FIG. 4 Top view of thumb pick of this invention shown without band.

FIG. 5 Side view of thumb pick of prior art contoured pick with band.

FIG. 6 Side view of a thumb pick of this invention shown with band.

FIG. 7 Top view of an alternate embodiment of a finger pick of this invention.

FIG. 8 Same as FIG. 7 but shown as a side view.

FIG. 9 Top view of an alternate embodiment of a finger pick of this invention, shown without a band.

FIG. 10 Top view of a finger pick of the prior art contoured pick, shown without a band.

FIG. 11 Same as FIG. 9 but showing a side view.

FIG. 12 Same as FIG. 10 but showing a side view.

FIG. 13 Same as FIG. 11 and FIG. 9 but showing a front view.

FIG. 14 Same as FIG. 12 and FIG. 10 but showing a front view.

FIG. 15 Same as FIG. 13 but showing a partial underside view.

FIG. 16 Same as FIG. 14 but showing a partial underside view.

FIG. 17 Thumb pick of this invention for a right hand thumb, shown without a band.

FIG. 18 Thumb pick of prior art contoured pick shown without a band.

FIG. 19 Point cloud of a 3d scanned model of a right hand thumb, points displayed using 3D CAD software.

FIG. 20 Thumb surface created from the point cloud of FIG. 19 comprising a network of intersecting mathematical curves.

FIG. 21 Thumb surface created from the point cloud of FIG. 19 comprising a network of linked polygons.

FIG. 22 Thumb surface of FIG. 20 upon which a contour surface has been drawn and through which an encroachment curve has been constructed.

FIG. 23 Same as FIG. 22 but showing a front view.

FIG. 24 Same as FIG. 23 but showing the front view from a slightly different perspective.

FIG. 25 Same as FIG. 22 but showing a side view.

FIG. 26 Transparent top view of the thumb surface of FIG. 22 shown with the longitudinal line of symmetry and the origin.

FIG. 27 Inner perimeter curve shown at a side view, also shown with curve of thumb nail for perspective.

FIG. 28 Inner perimeter curve and thumb nail curve shown at a front view.

FIG. 29 Modified longitudinal curves and modified lateral curves which will form the network of curves that define the shape of the modified thumb surface.

FIG. 30 Modified thumb surface showing the inner perimeter curve and the upper encroachment boundary, with the original lower longitudinal curve and several of the original lateral curves shown for comparison.

FIG. 31 The inner saddle surface formed by cutting the modified thumb surface with the inner perimeter curve. Also shown is the upper encroachment boundary with the original lower longitudinal curve and several of the original lateral curves shown for comparison.

FIG. 32 Front view of the inner saddle surface with the original lower longitudinal curve and several of the original lateral curves shown for comparison.

FIG. 33 A top and rearward view of the inner saddle surface, also shown with the original lower longitudinal curve and several of the original lateral curves shown for comparison.

FIG. 34 A rearward view of both the inner and outer saddle surfaces and the offset distance between the two surfaces.

FIG. 35 Inner and outer perimeter curves are shown connected with perimeter connecting strip lateral curves to define the shape of the perimeter connecting strip (not shown).

FIG. 36 The perimeter connecting strip formed from the network of curves of FIG. 35.

FIG. 37 A fully enclosed pick saddle for a thumb pick of this invention.

FIG. 38 A top view of the pick saddle of FIG. 37 shown with a circular area that will be enlarged for FIG. 39.

FIG. 39 An enlarged view of a portion of FIG. 38 showing the inner and outer post inset curves.

FIG. 40 An enlarged view of a portion of FIG. 38 showing the area of the pick saddle that has been cutout with the inner and outer post inset curves.

FIG. 41 The post upper and post lower cutouts formed from cutting the inner and outer surfaces with the inner and outer post inset curves.

FIG. 42 Upper and lower post perimeter curves shown with the inner and outer post inset curves but shown without the cutout surfaces for clarity.

FIG. 43 Post upper and post lower formed by cutting the upper and lower post cutouts with the upper and lower post perimeter curves.

FIG. 44 Rearward view of the post upper and post lower shown with the inner and outer post inset curves.

FIG. 45 Post connecting strip shown with the post upper and post lower.

FIG. 46 Rearward view of the inner and outer post inset curves.

FIG. 47 Post connecting strip.

FIG. 48 The post assembly formed by joining the post inset connecting strip, the post connecting strip, and the post upper and post.

FIG. 49 Side view of the post assembly also showing an area where the post connecting strip overlaps with the post inset connecting strip.

FIG. 50 Side view of the post assembly after the post has been rotated upward to avoid the overlap of FIG. 49 and to allow easy attachment of the band.

FIG. 51 Rearward view of a portion of the pick saddle and the post assembly showing how the post assembly fits into the pick saddle.

FIG. 52 Same view as FIG. 51 but with the post assembly in place on the pick saddle.

FIG. 53 Rearward view of the modified pick saddle.

FIG. 54 Lower rear view of modified pick saddle with pick element inset curve drawn on the surface.

FIG. 55 Same view as FIG. 54 of modified pick saddle with the outer surface cut away by the pick element inset curve.

FIG. 56 First embodiment of the pick element for a right hand thumb pick, shown at a view corresponding to the view of FIG. 54.

FIG. 57 Pick element shown with view corresponding to view of FIG. 55.

FIG. 58 2^{nd} embodiment of modified pick saddle formed by combining modified pick saddle of FIG. 55 with pick element of FIG. 56.

FIG. 59 Same 2^{nd} embodiment of modified pick saddle of FIG. 58 shown in the same view as FIGS. 55 and 57.

FIG. 60 Same modified pick saddle as FIG. 58 but shown as an underside view.

FIG. 61 Side view of an elastic band of this invention.

FIG. 62 Front view of an elastic band of this invention.

FIG. 63 1^{st} step in the installation of the elastic band onto the pick saddle—band is threaded under the post.

FIG. 64 2^{nd} step in the installation of the elastic band—post is twisted as shown in the drawing.

FIG. 65 3^{rd} step in the installation of the elastic band—post is pushed below the surface of the pick saddle.

FIG. 66 4^{th} step in the installation of the elastic band—post is rotated back from its twisted position and rests with the band beneath the surface of the saddle.

FIG. 67 2^{nd} embodiment of a thumb pick of this invention as it would be worn on a thumb.

FIG. 68 Four different thumb shapes each differing only in the profile angle.

FIG. 69 Four different thumb pick saddles created according to the method of multiple variations of 3d CAD models, each pick model formed to the shape of the corresponding thumb shown in FIG. 68.

FIG. 70 Three different thumb shapes each differing only in the thickness or height.

FIG. 71 Three different thumb pick saddles created according to the method of multiple variations of 3D CAD models, each pick model formed to the shape of its corresponding thumb in FIG. 70.

FIG. 72 Right handed thumb pick of this invention shown with a mirror image for a left thumb formed according to the method of multiple variations of 3D CAD models.

FIG. 73 Eight variations of a right hand thumb pick, each differing only in the shape and size of the pick element, formed according to the method of multiple variations of 3D CAD models.

FIG. 74 An example of six different thumb shapes seen from a top view.

FIG. 75 A thumb sizing chart which could be used to choose the correct size of a thumb pick.

FIG. 76 Cross-sectional front view of a right hand thumb pick at the point on the longitudinal axis of the maximum width of the post, showing the unique shape of the post and post inset.

FIG. 77 Same view as FIG. 76 showing how the wall thickness of a pick of this invention can be varied to enhance or reduce flexibility of the pick.

FIG. 78 Enlargement of the circular area of FIG. 76 showing the unique design of the post longitudinal walls and the post inset longitudinal walls.

FIG. 79 Top view of a thumb pick showing the longitudinal axis and three of any number of cross-sectional planes which can exist along the longitudinal axis that would also intersect the longitudinal walls of the post.

FIG. 80 Front view of a cross-sectional slice of a right hand thumb pick, also showing the longitudinal axis and the longitudinal plane of symmetry.

FIG. 81 Front view of right hand thumb pick showing three cross-sectional slices that intersect the longitudinal walls of the post.

FIG. 82 Enlarged view of FIG. 81 showing the most distal of the three cross sections of FIG. 81, also showing the contribution of the thickness of the elastic band in preventing the band from pulling the post upward during use.

FIG. 83 Side view of the preferred embodiment of a finger pick of this invention, showing the open area of the saddle near the fingertip, the lower extent of the encroachment surface, and the semi-oval ring shape of the pick element.

FIG. 84 Side view of prior art contoured finger pick as a comparison to FIG. 83.

FIG. 85 Lower and somewhat front view of the finger pick of FIG. 83.

FIG. 86 Lower and frontal view of prior art contoured pick as a comparison to FIG. 85.

FIG. 87 Underside view of the finger pick of FIG. 83 showing the asymmetry of the shape of the ring of the pick element from one side of the longitudinal axis to the other.

FIG. 88 Front and lower view of the finger pick of FIG. 83 showing that the asymmetrical design of the ring shape is due to the direction of travel of the string as it is being plucked.

FIG. 89 Side view of 2^{nd} alternate embodiment of a thumb pick of this invention, showing a pick element where a substantial portion of the upper surface has been removed to reveal the thumb.

FIG. 90 Top view of FIG. 89.

FIG. 91 3^{rd} alternate embodiment of a thumb pick of this invention, showing that a substantial portion of the striking surface of the pick element has been removed, leaving a perimeter of material in a somewhat ring-like shape.

FIG. 92 4^{th} alternate embodiment of a thumb pick of this invention, showing that the thickness of the striking portion of the pick element has been increased and formed into a wedge shape.

FIG. 93 Shoe last and foot from which it was made

FIG. 94 Overhead view of outline of foot and outline of shoe last to be constructed using the foot outline

FIG. 95 Side view or profile of foot showing traditional measuring points for creating a foot last

FIG. 96 Top or overhead view of a 3D CAD model of a foot

FIG. 97 Side profile of a 3D CAD model of a foot

FIG. 98 Overhead view of base foot and base shoe models

FIG. 99 Overhead view of base foot and base shoe models superimposed

FIG. 100 Overhead view of base foot and shoe models indicating that they will be stretched perpendicular to the longitudinal axis

FIG. 101 Overhead view of the outlines of same base foot and shoe models of FIG. 100 shown separately

FIG. 102 Overhead view of a 1^{st} stretch operation of the base foot and shoe models, the stretch done perpendicular to and away from the longitudinal axis

FIG. 103 Overhead view of a 2^{nd} stretch operation of the base foot and shoe models, the stretch done at a higher degree than FIG. 102, perpendicular to and away from the longitudinal axis

FIG. 104 Overhead view of a 3^{rd} stretch operation of the base foot and shoe models, the stretch done perpendicular to and toward the longitudinal axis

FIG. 105 Superimposed base foot/shoe model pair showing that a stretch operation will stretch both in the direction of the longitudinal axis

FIG. 106 Foot/shoe variations as a result of three stretch operations on the base model pair in the direction of the longitudinal axis

FIG. 107 Front and side view of a base foot model

FIG. 108 Overhead view of the base foot model of FIG. 107

FIG. 109 Front and side view of a base foot model showing the instep axis, the instep vertical plane, and the subsequent rotations and intersections of the instep vertical plane to produce multiple closed curves

FIG. 110 Same view of FIG. 109 showing multiple closed curves originating from the upper instep node

FIG. 111 Overhead view of three stretch operations on a base foot/shoe model pair, the stretch operation being in the direction of the longitudinal axis with the area to be stretched bounded on the lower side by the lower inset node and bounded on the upper side by the distal node

FIG. 112 Overhead view of similar stretch operations of FIG. 111 but with the stretched area bounded on the upper side by the lower instep node and bounded on the lower side by the proximal node

FIG. 113 Overhead of a superimposed base foot/shoe model pair showing that a tapering stretch operation will be performed with the area to be stretched bounded as shown, the greater amount of stretch to occur in the distal portion of both models, the tapered stretch to be performed perpendicular to and away from the longitudinal axis

FIG. 114 Outlines of the foot/shoe model pair following the stretch operation indicated in FIG. 113

FIG. 115 Overhead view of a the models of FIG. 113 following the tapered stretch of both models

FIG. 116 Overhead view of a tapered stretch of greater magnitude of the base foot/shoe model pair of FIG. 113

FIG. 117 Overhead view of a tapered stretch of the base foot/shoe model pair similar to FIG. 113 but with the direction of the stretch toward the longitudinal axis

FIG. 118 Base foot model shown as a side profile view

FIG. 119 Base shoe model shown as a side profile view

FIG. 120 Side profile view of a base foot/shoe model pair indicating that a tapered stretch operation is to be performed in a plane in a vertical plane running through the longitudinal axis, the stretch operation to be perpendicular and away from the longitudinal axis, bounded at the start by the center joint node and at the end by the proximal node

FIG. 121 Side profile view of the resultant shoe model of a foot/shoe model pair of a tapered stretch operation indicated in FIG. 120

FIG. 122 Side profile view of the foot model companion of the shoe model of FIG. 121

FIG. 123 Side profile view of resultant foot/shoe model tapered stretch operation similar to the one of FIG. 120, but with the direction of the tapered stretch toward the longitudinal axis

FIG. 124 Front and side view of a base foot model showing the upper and lower heel nodes, the heel girth plane, joint girth plane, heel girth curve, and joint girth curve

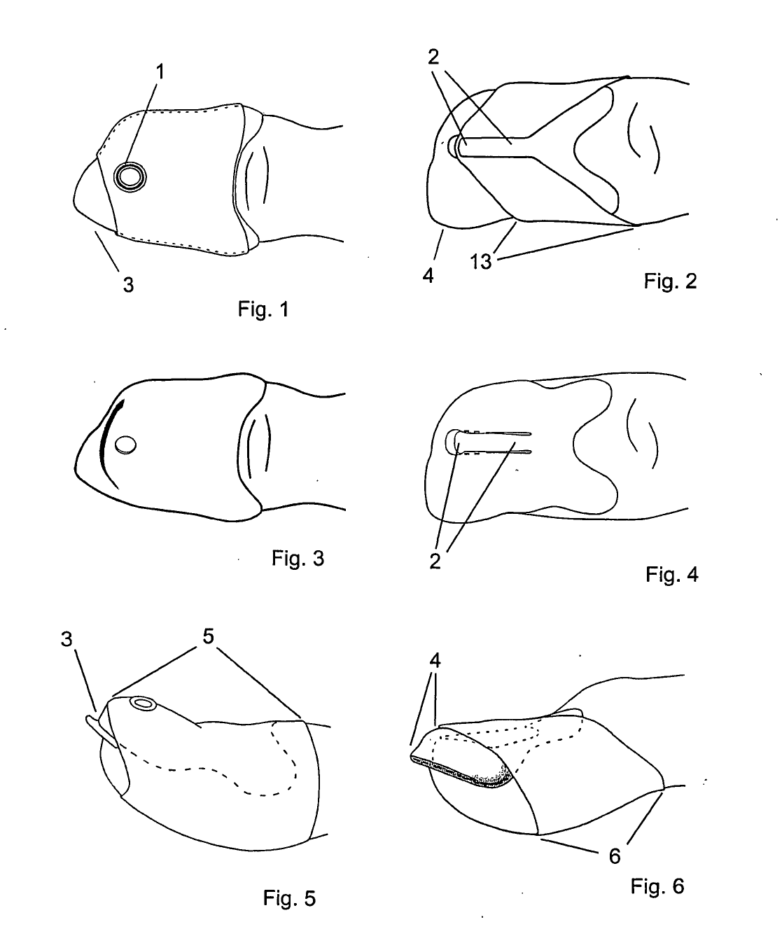

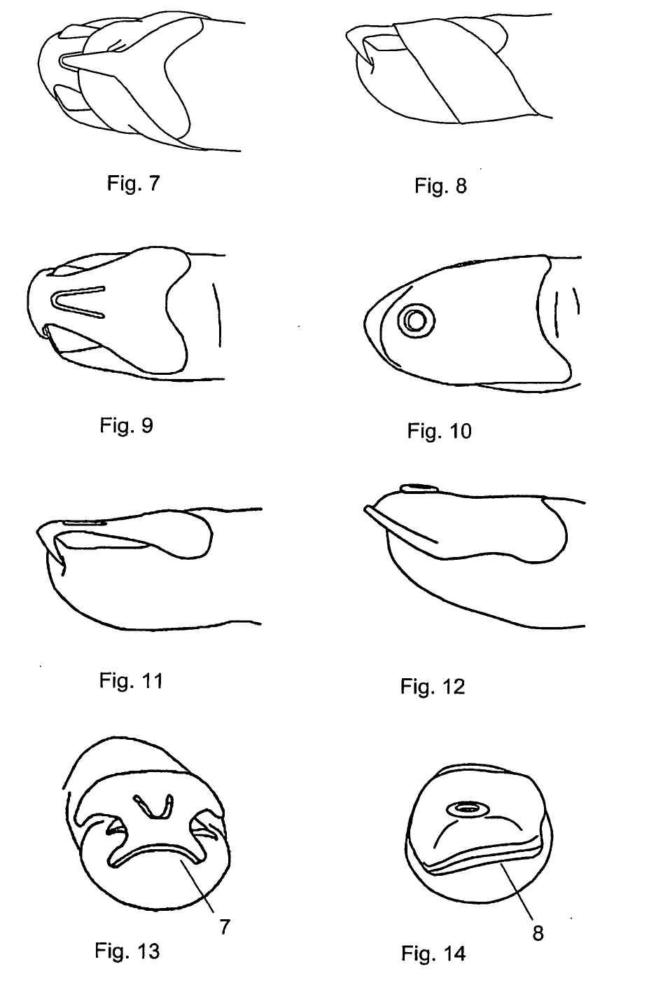

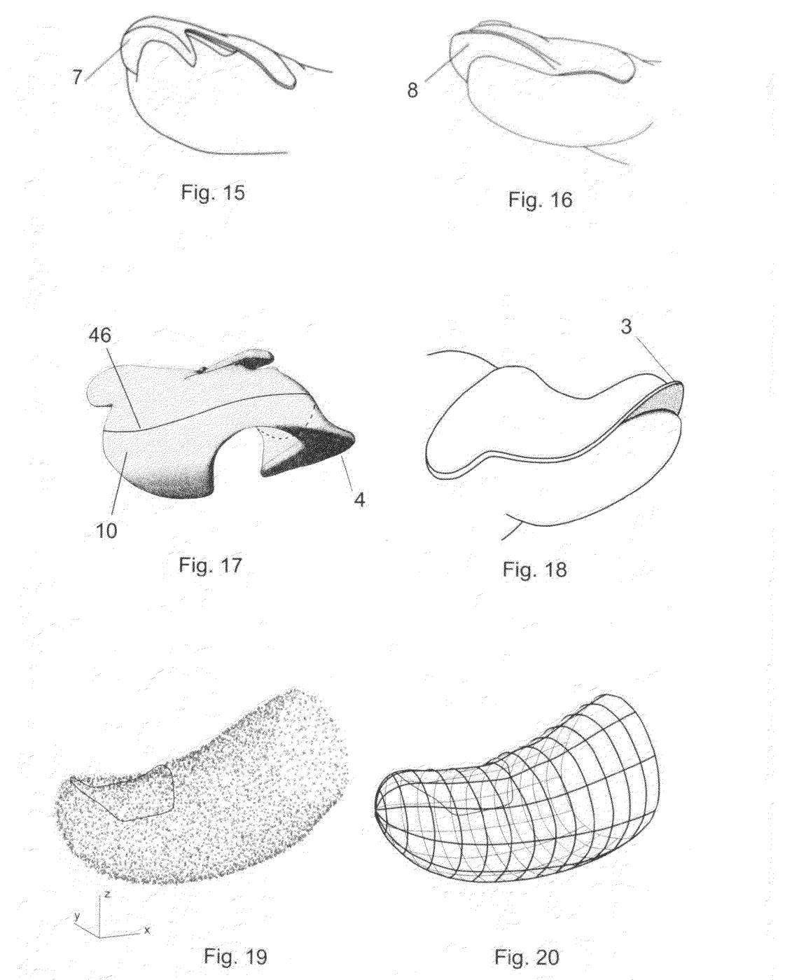

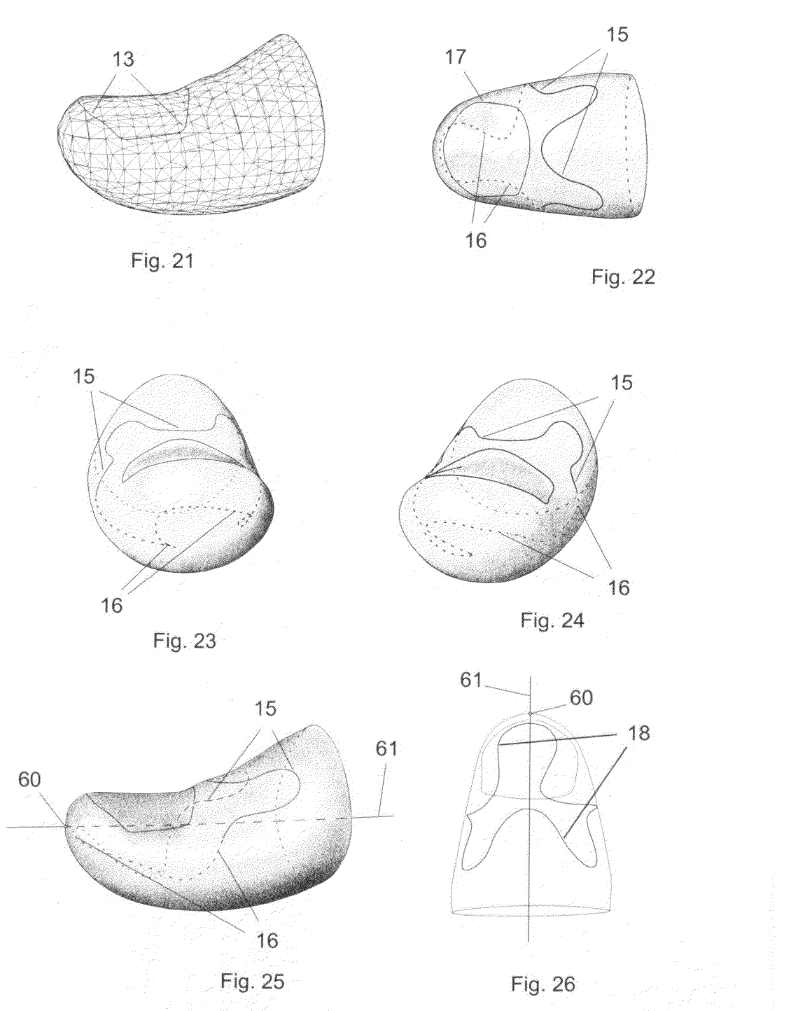

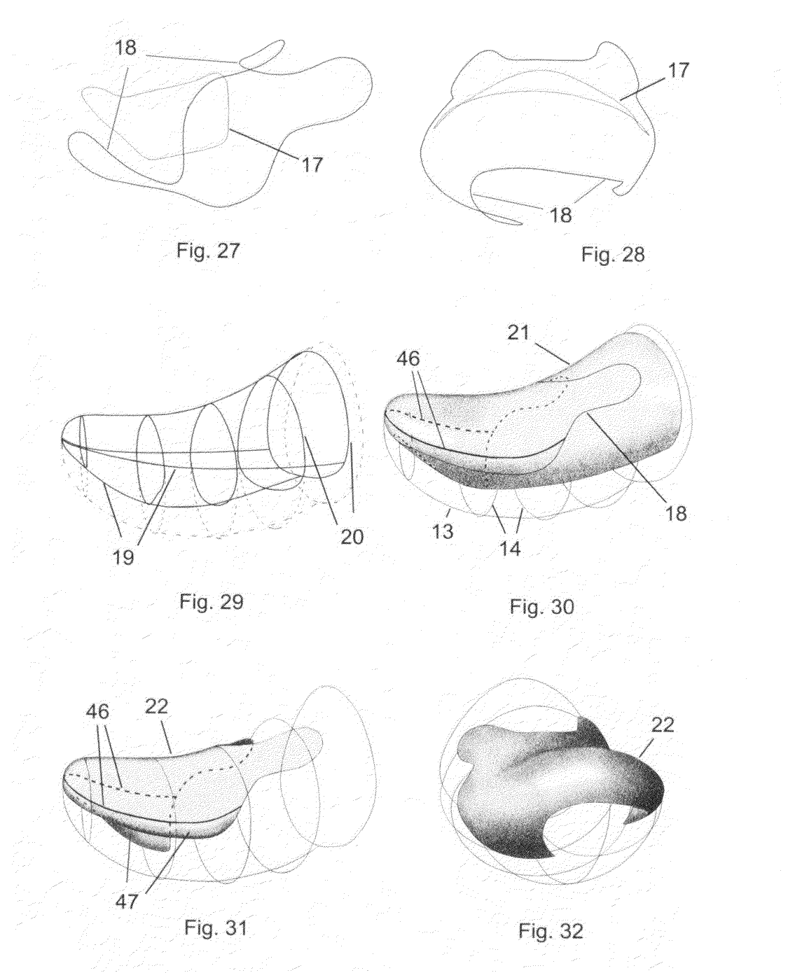

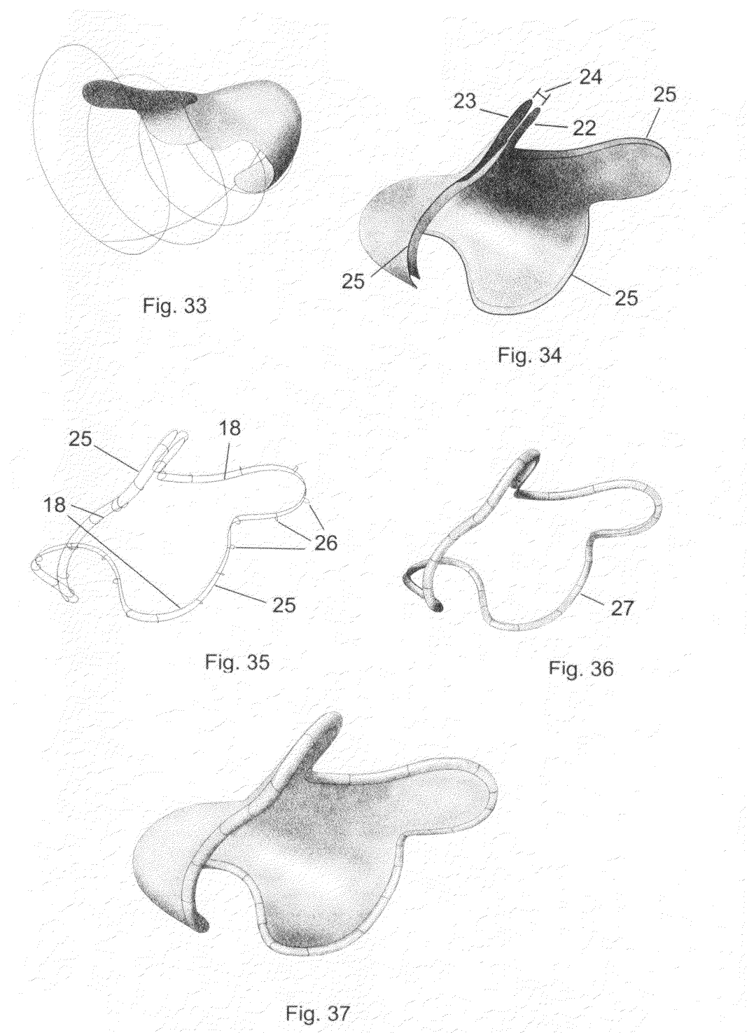

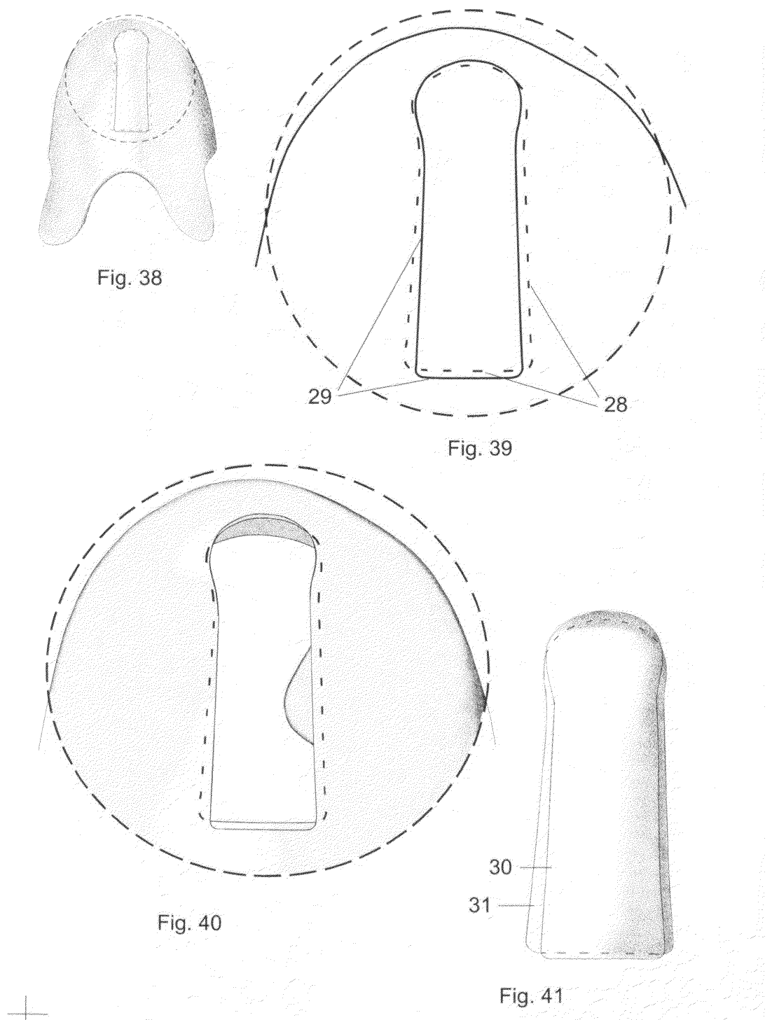

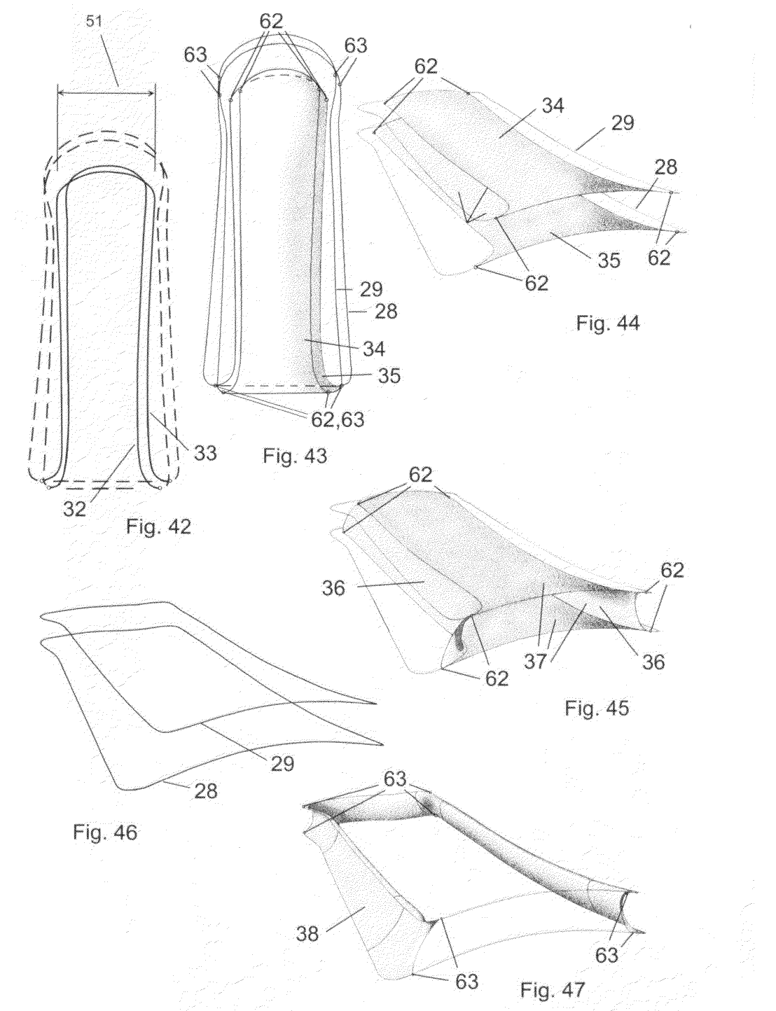

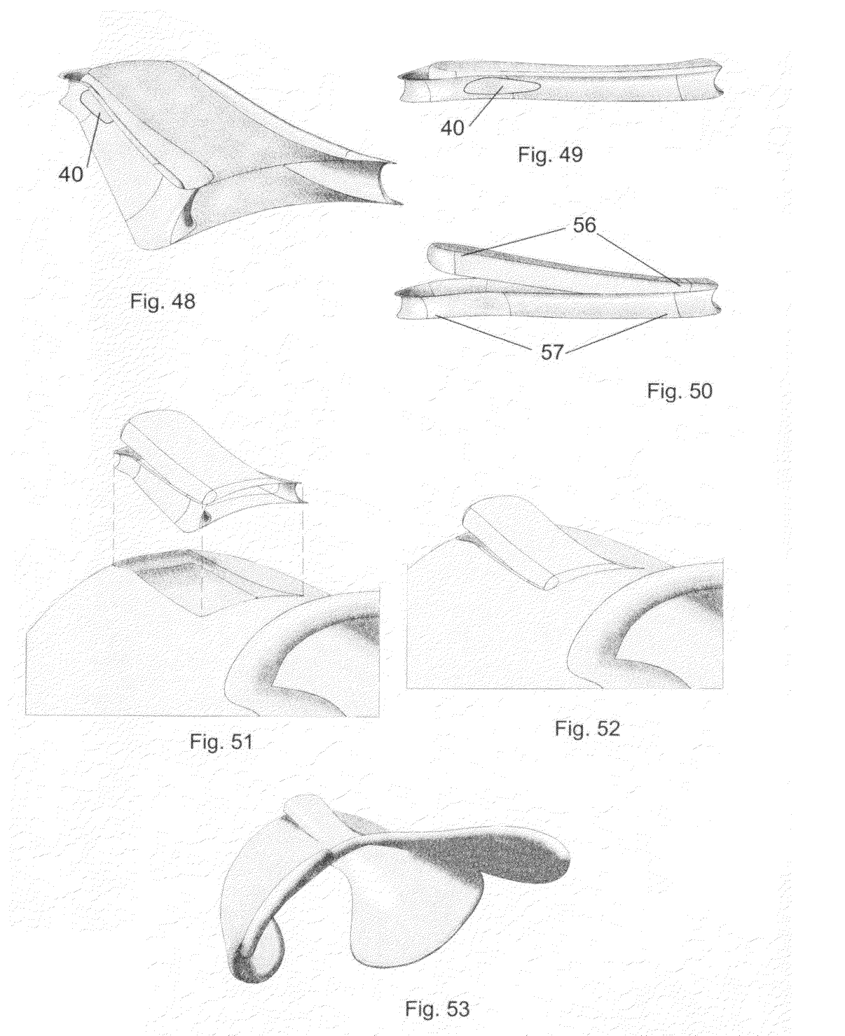

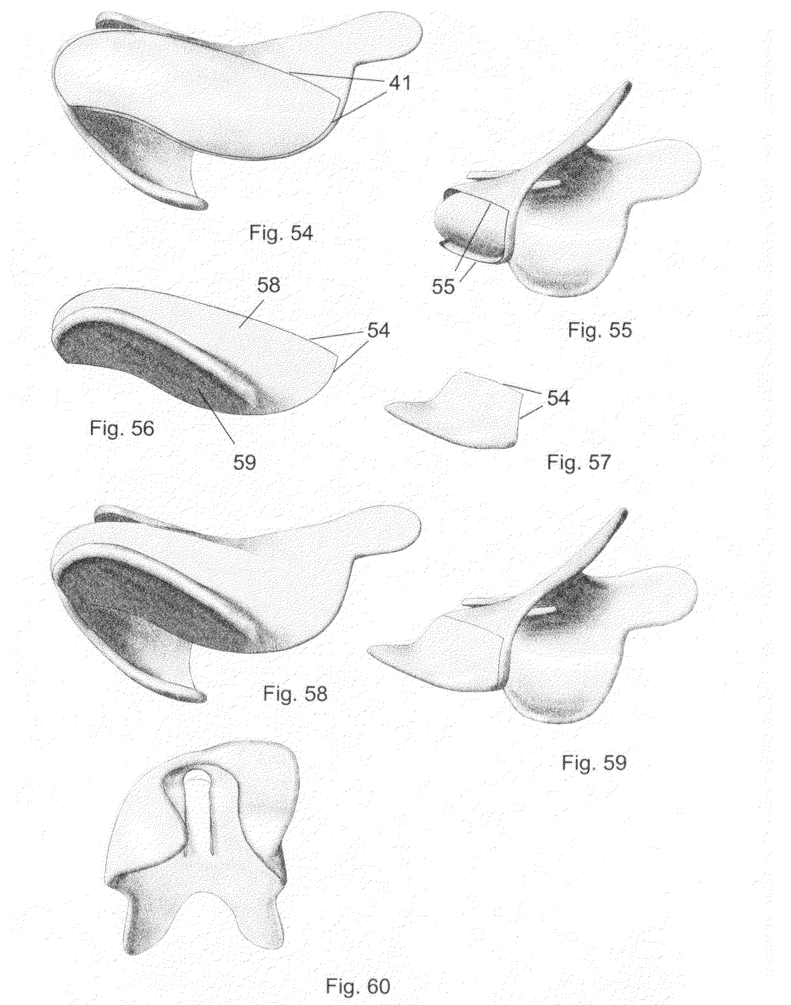

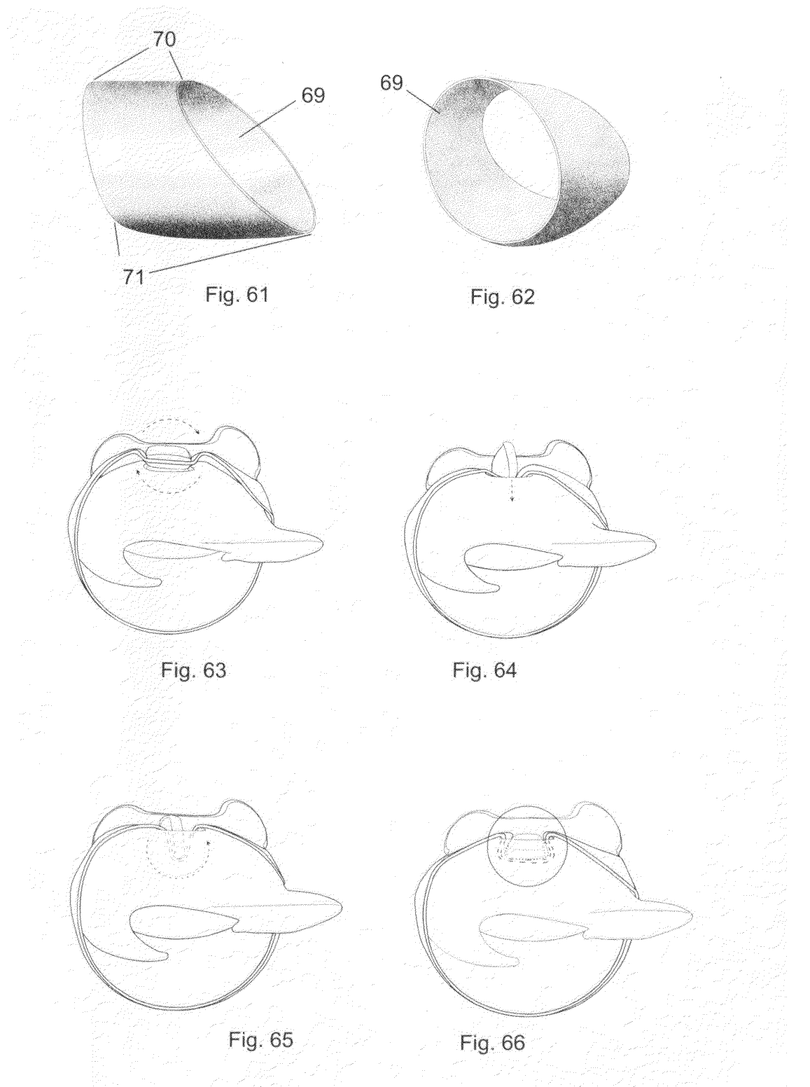

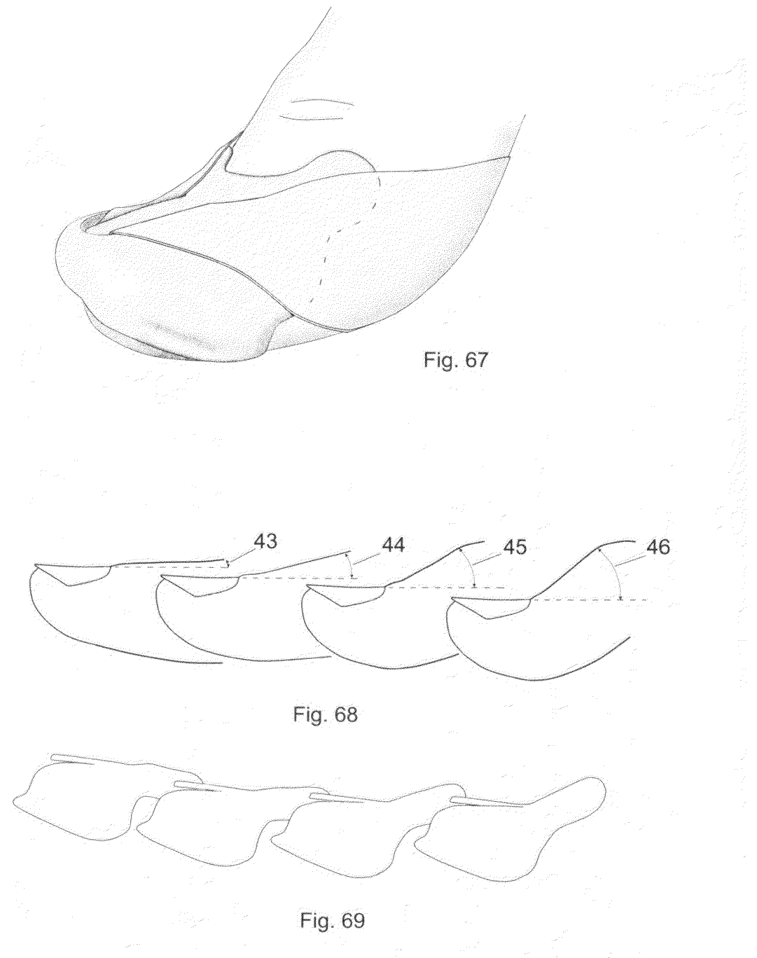

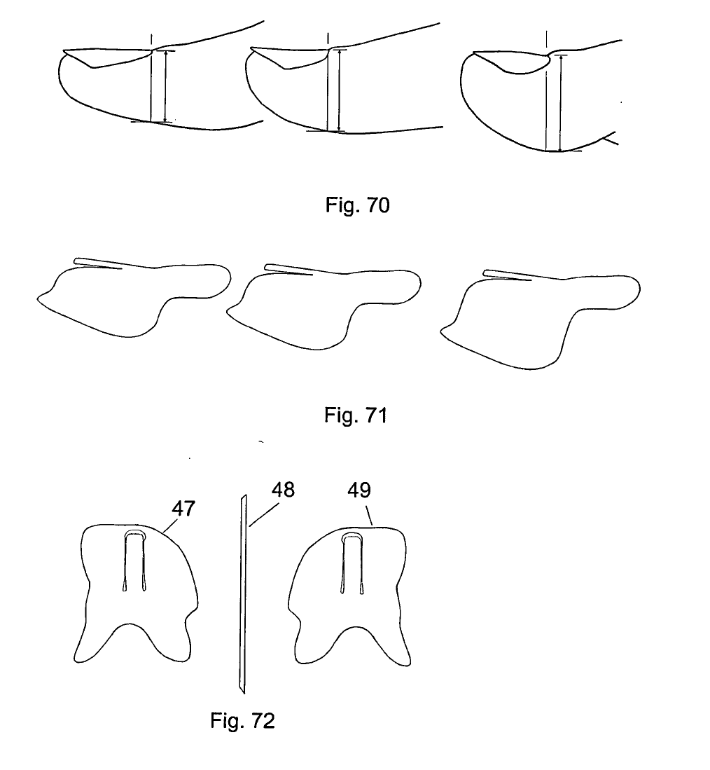

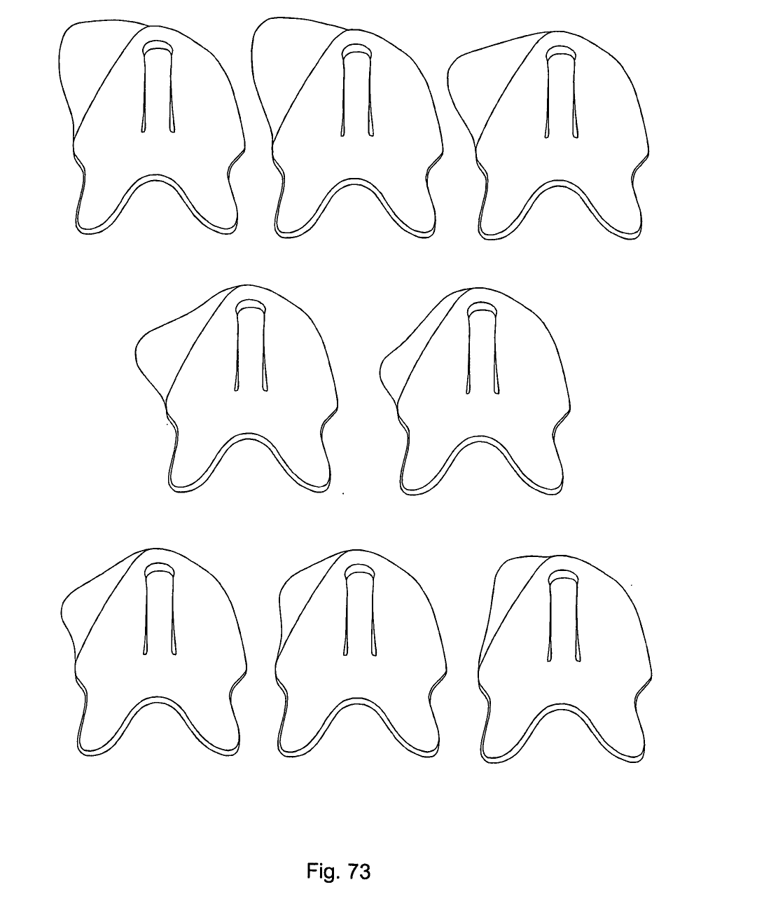

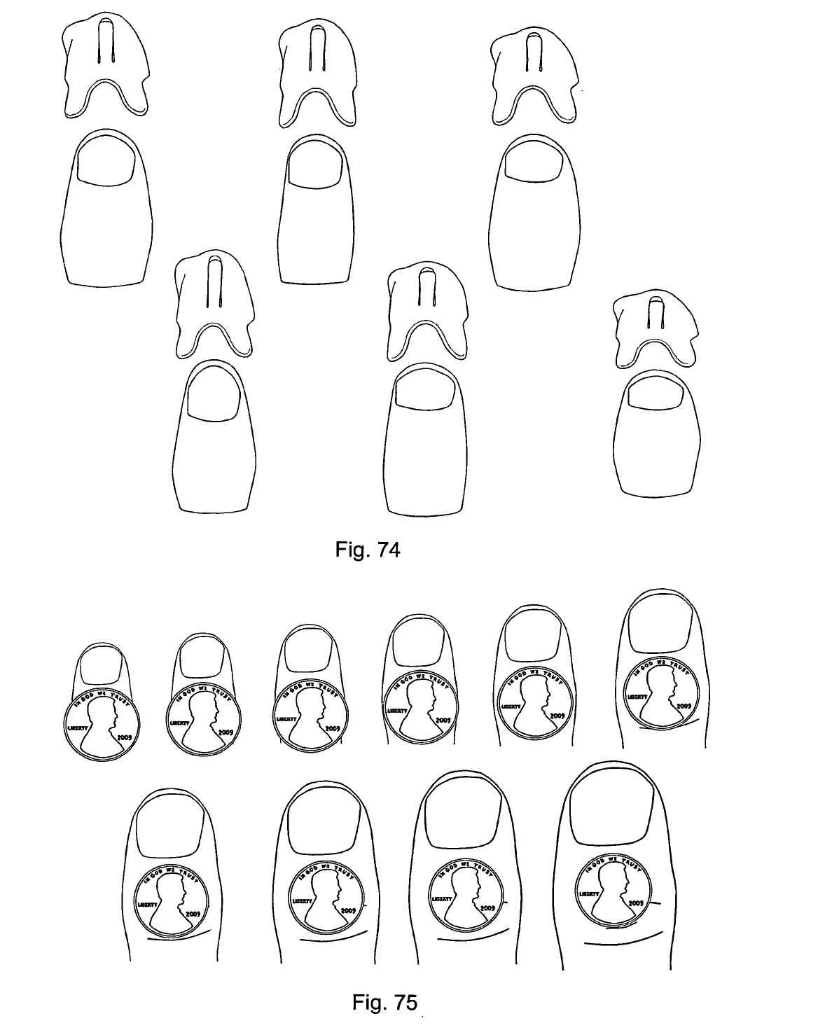

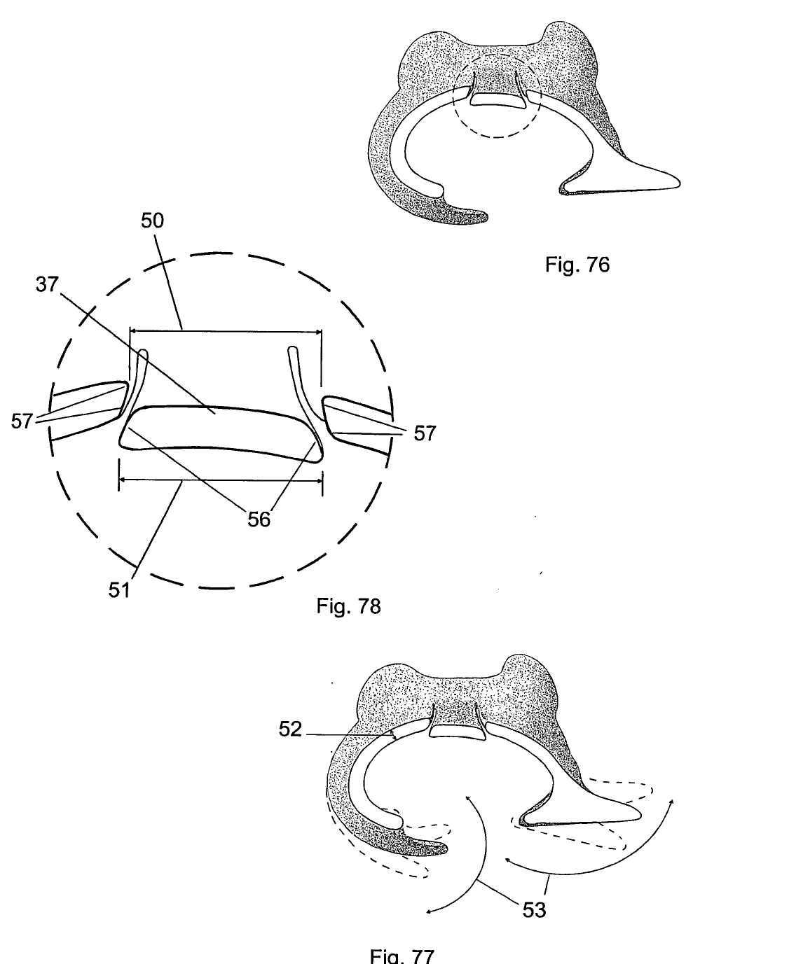

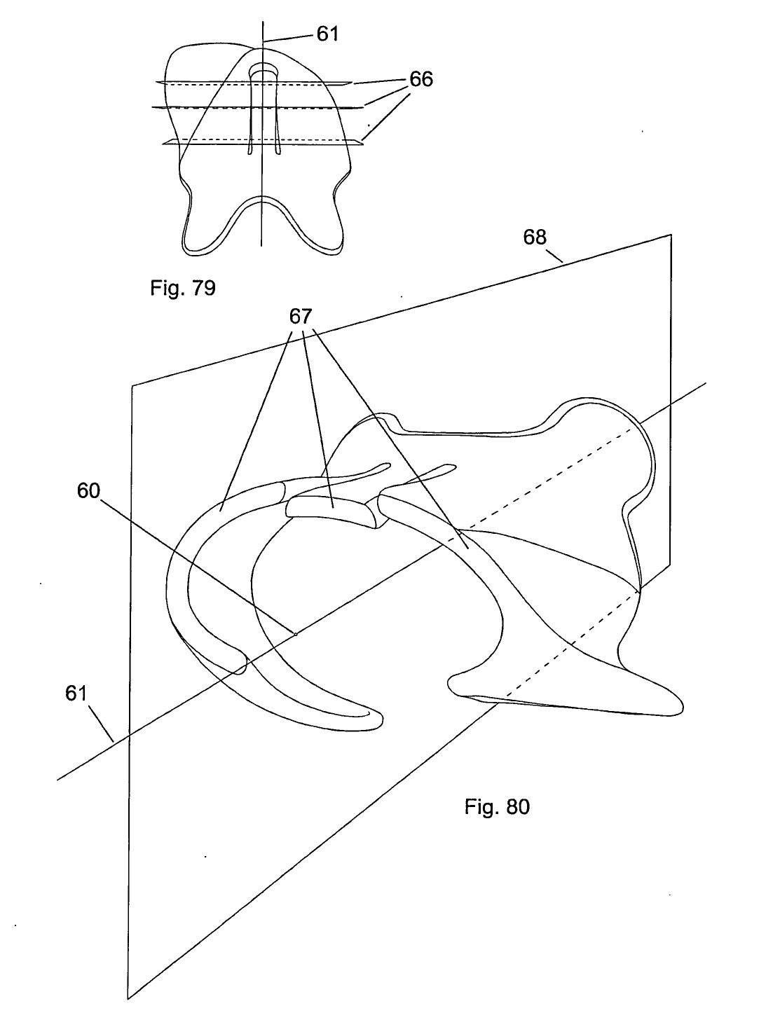

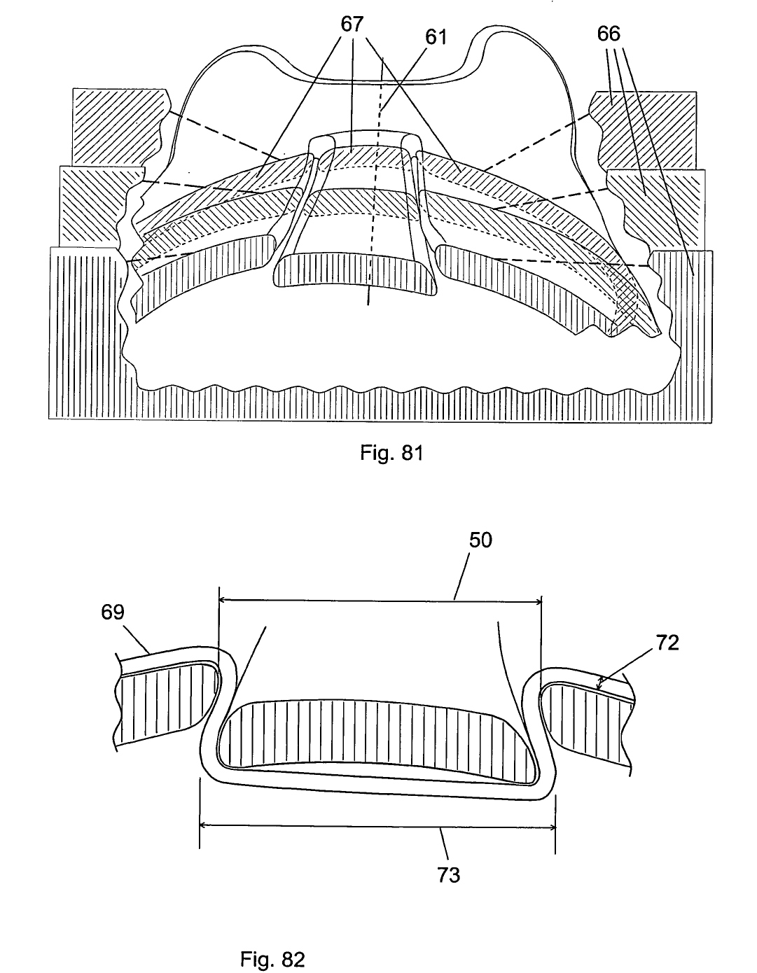

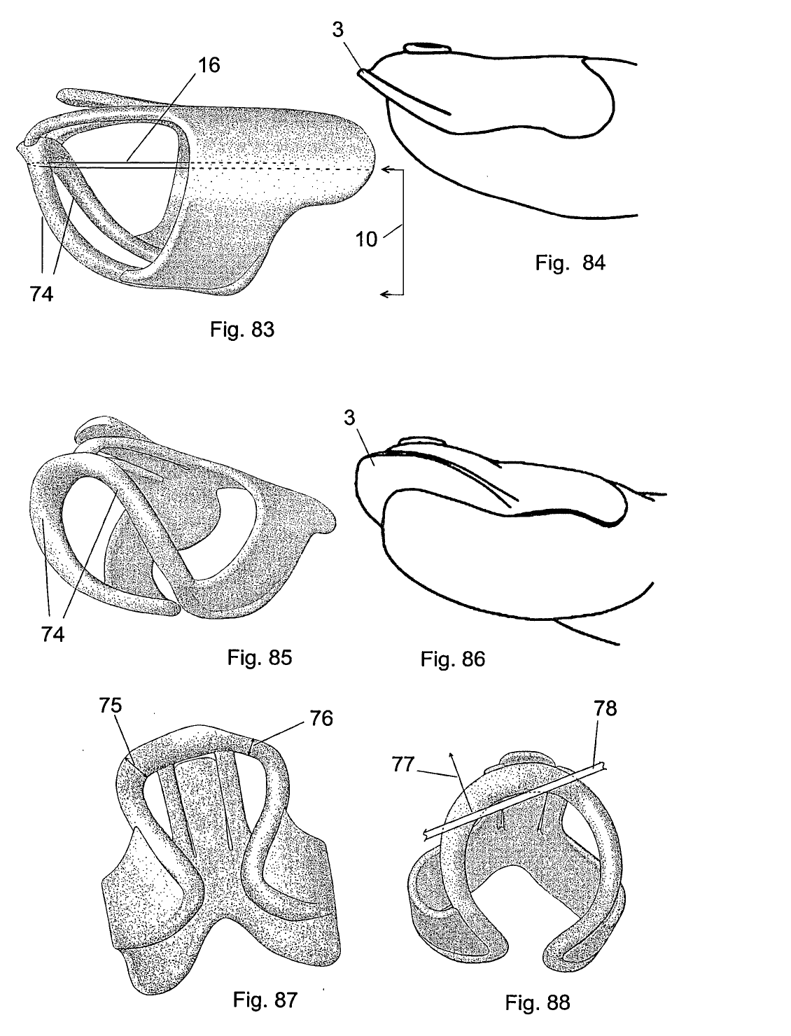

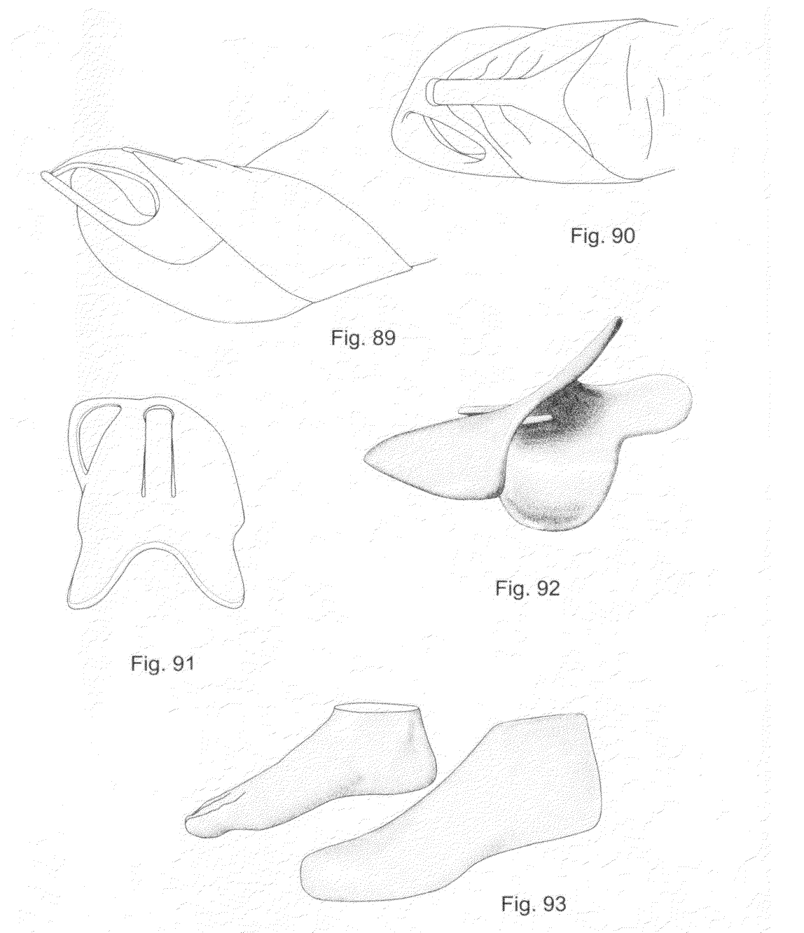

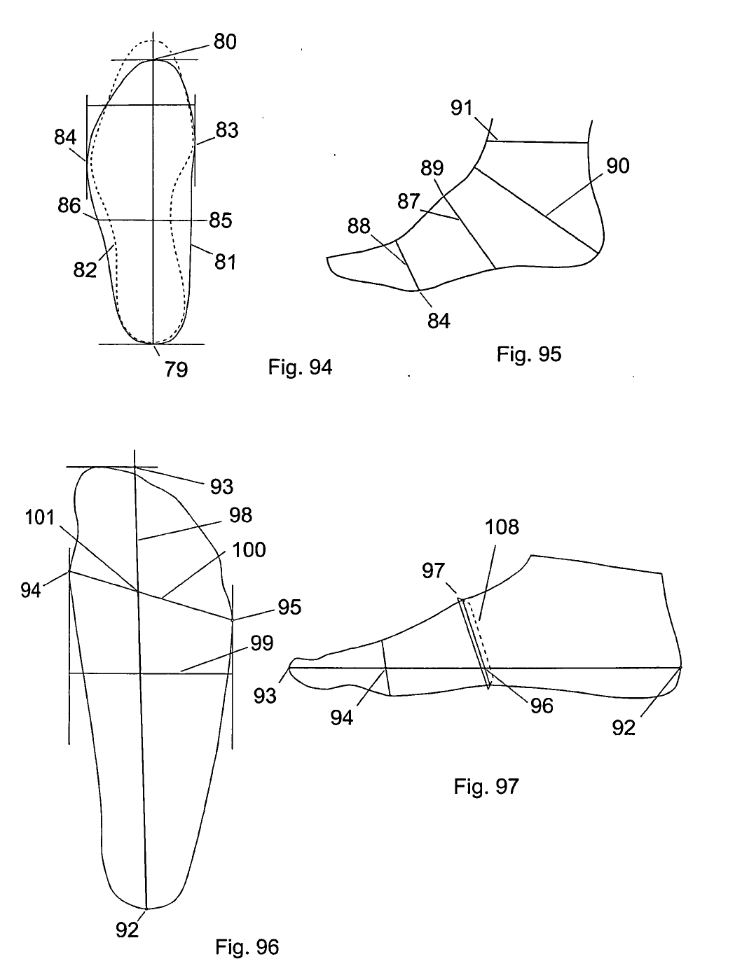

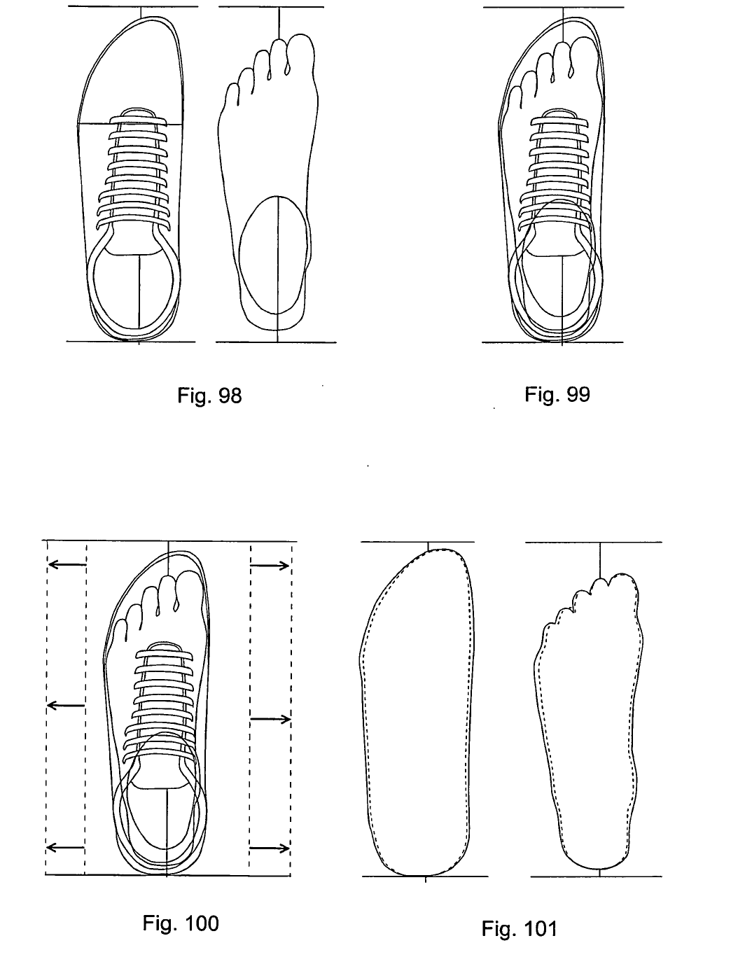

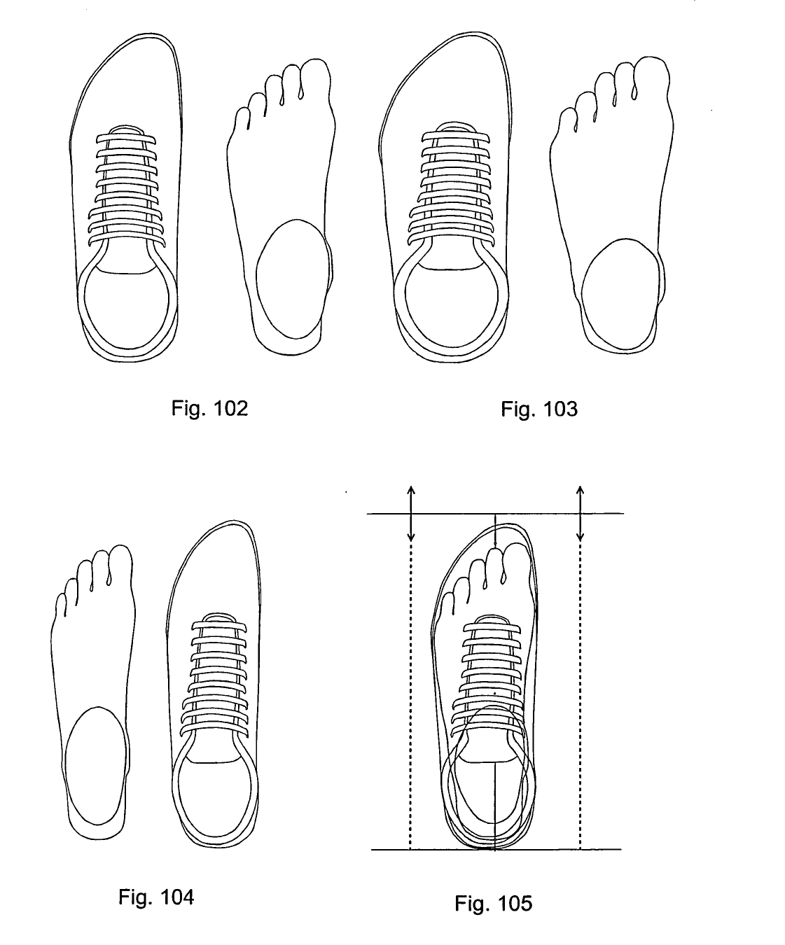

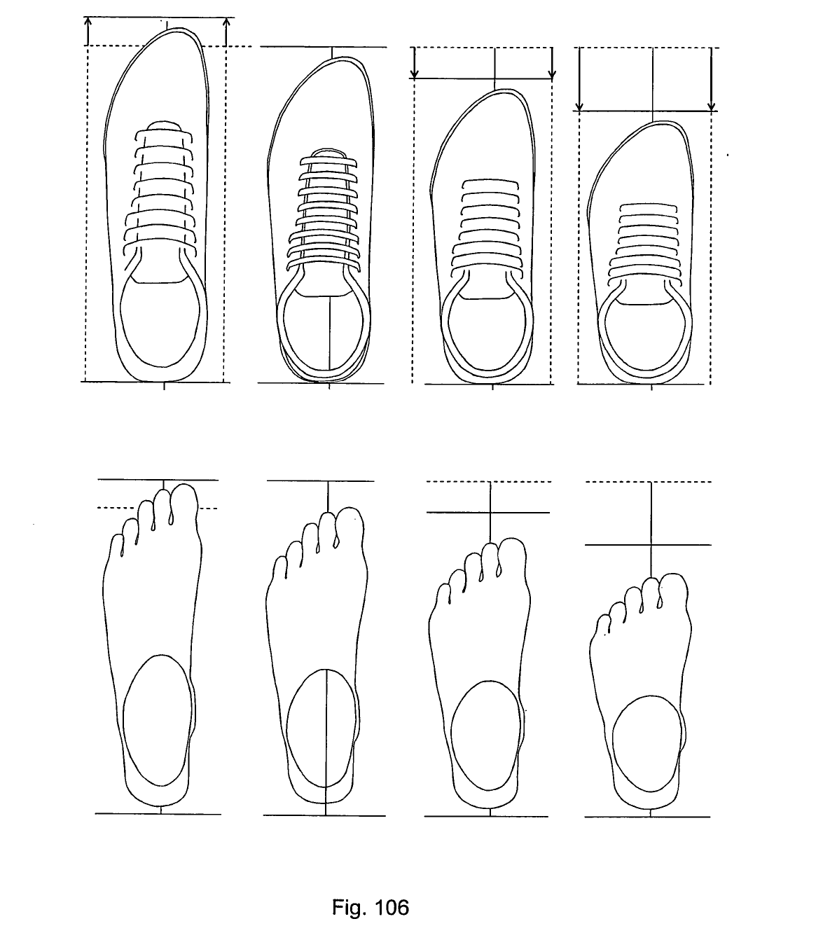

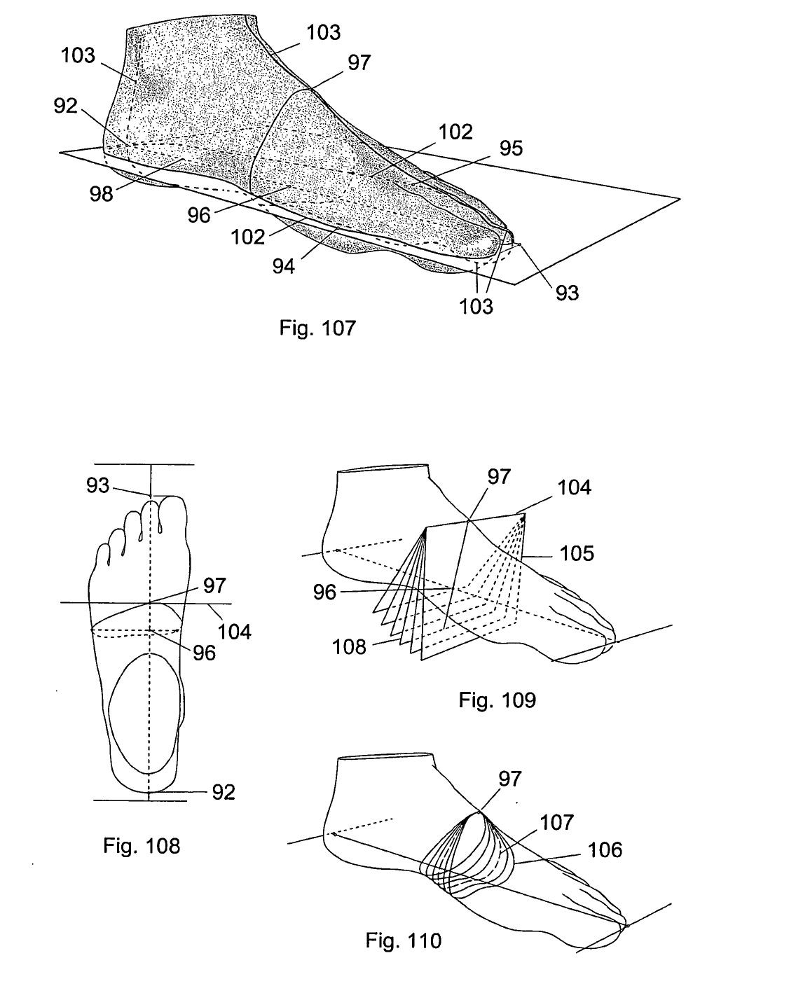

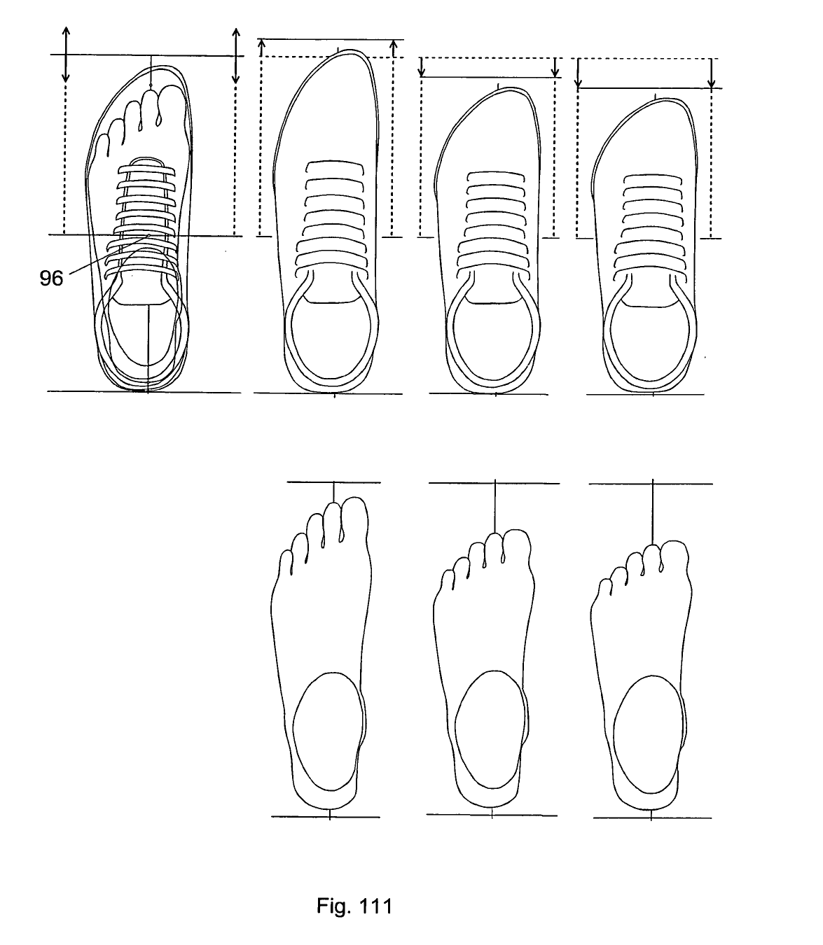

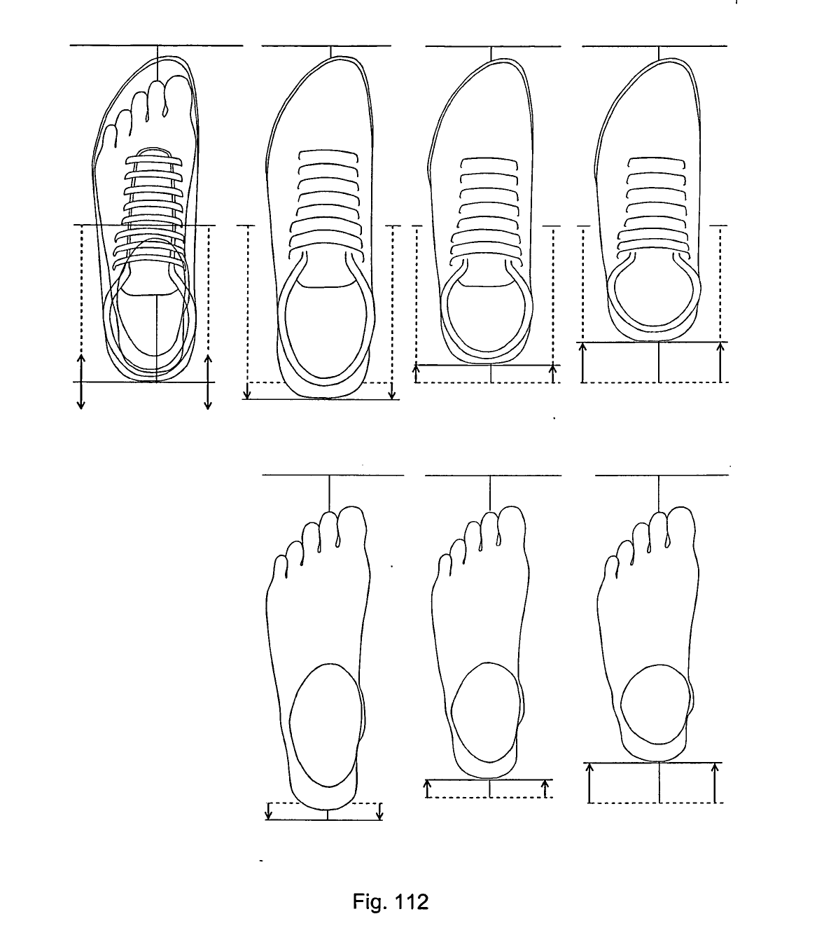

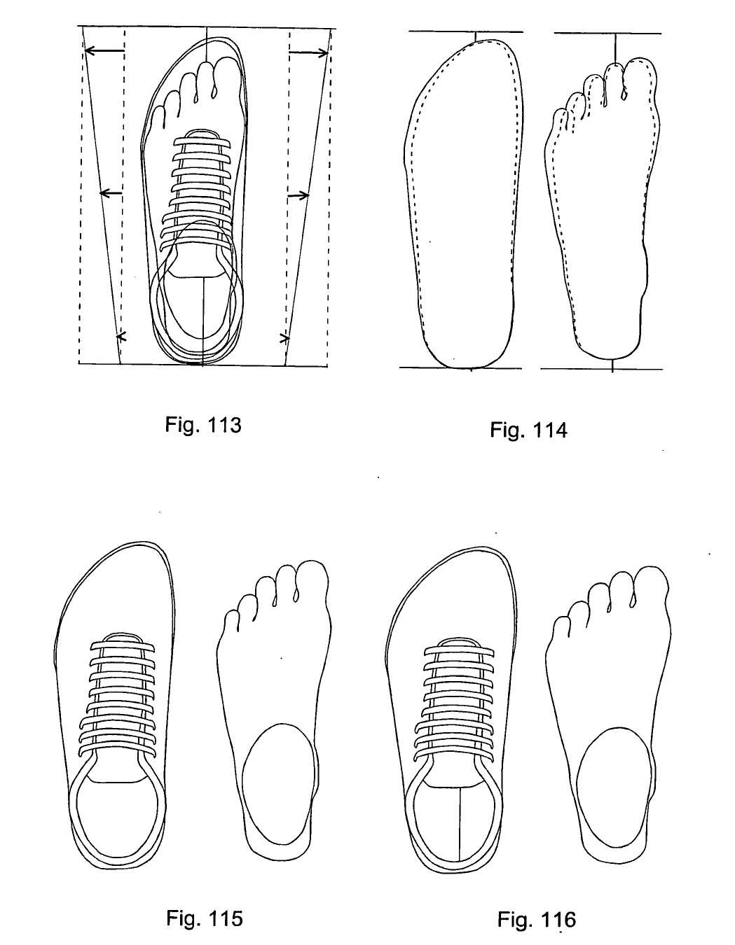

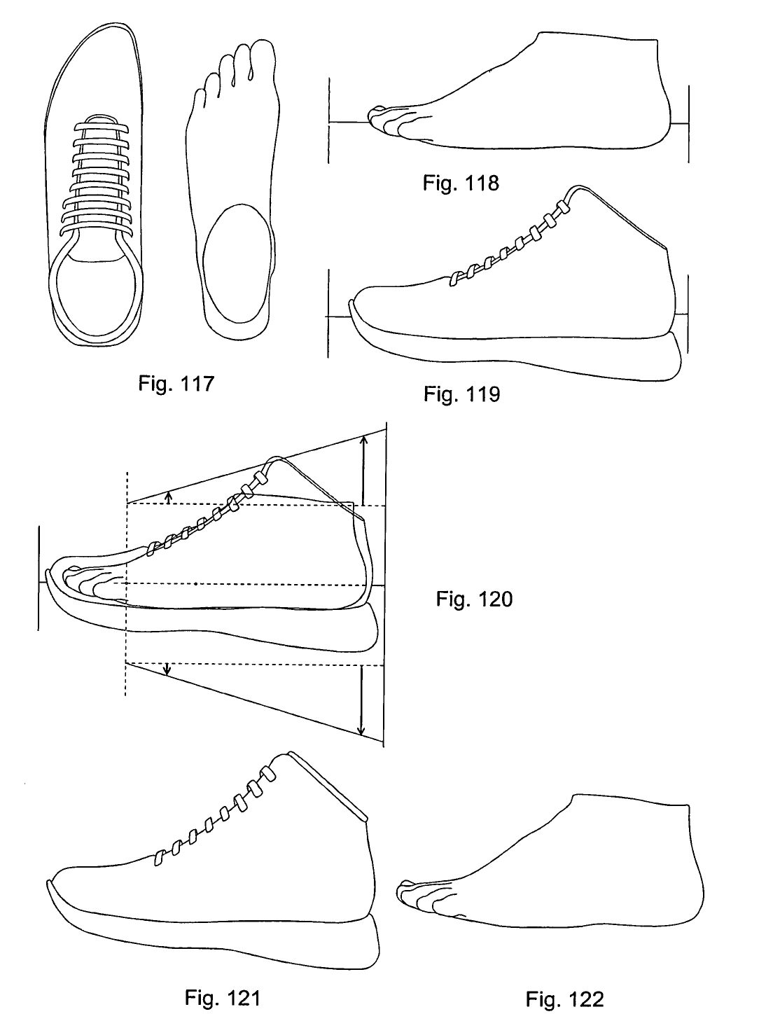

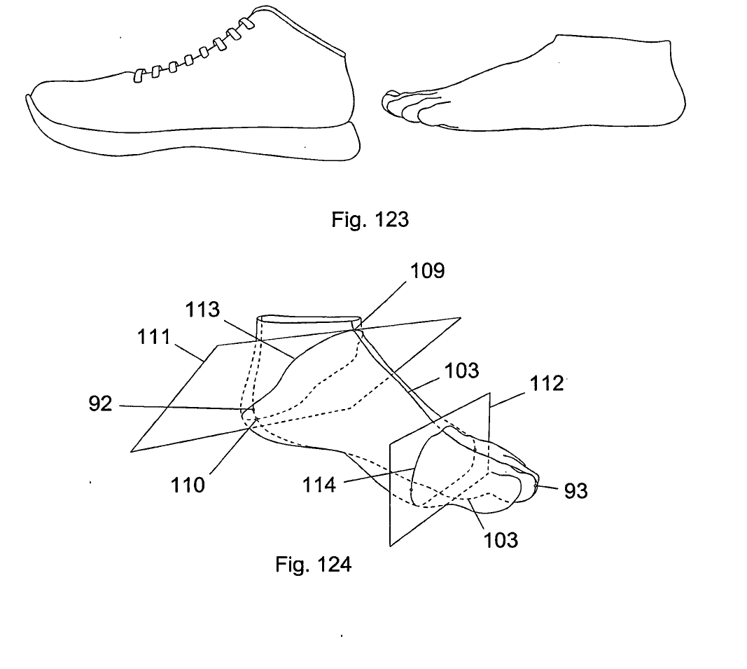

### LIST OF REFERENCE NUMERALS

1. Preferred securing means of the elastic band to the pick saddle of prior art “contoured pick”. An eyelet is used to secure the band to the saddle.
2. Securing means of this invention of the elastic band to the pick saddle. This “U” shaped cavity in the surface of the saddle creates the securing post.
3. The pick flange for a thumb pick of prior art “contoured pick”. It is the part which strikes the string of the stringed musical instrument.
4. The pick element of a thumb pick of this invention. It has a lower surface for downstrokes, and a smooth upper surface for backstrokes.
5. The elastic band of prior art contoured pick.
6. The elastic band of the improvement.
7. Alternate embodiment of a pick element of this invention for a finger pick, showing curvature in the lateral direction.
8. The pick flange for a finger pick of prior art contoured pick.
9. (Intentionally omitted)
10. Encroachment surface
11. (Intentionally omitted)
12. A virtual 3D surface of a thumb constructed of a network of intersecting longitudinal and lateral curves which define the surface of the thumb.
13. Longitudinal curves of a 3D CAD model constructed of a network of curves.
14. Lateral curves of a 3D CAD model constructed of a network of curves.
15. The contour curve which defines the shape and perimeter of the pick saddle on the upper (upper) side of the thumb.
16. The lower encroachment curve which defines the perimeter of the pick saddle on the lower side of the thumb. It is named such because it encroaches past the surface of the thumb.
17. The outline of the thumb nail is only for clarity of the drawing.
18. The inner perimeter curve formed by joining the contour curve with the lower encroachment curve.
19. Modified longitudinal curve defining the modified thumb surface in the longitudinal direction.
20. Modified lateral curve defining the modified thumb surface in the lateral direction.
21. Modified thumb surface which will define the inner surface of the pick saddle.
22. The inner saddle surface formed by trimming the modified thumb surface with the inner perimeter curve.
23. Outer saddle surface formed by offsetting the inner saddle surface in an outward direction at an offset distance which determines the wall thickness of the pick saddle.
24. Offset distance is the distance at which the outer saddle surface is separated from the inner saddle surface.
25. Outer perimeter curve is the perimeter of the saddle outer surface.
26. Lateral curves of the perimeter connecting strip.
27. Perimeter connecting strip joining the saddle inner and outer shells to form a closed volume.
28. Inner post inset curve forms the edge of cavity known as the inner post inset.
29. Outer post inset curve borders the cavity called the outer post inset.
30. Post upper cutout is the part of the saddle outer shell cut out by the outer post inset curve.
31. Post lower cutout is that part cut out by the lower post inset curve.
32. Upper post perimeter curve.
33. Lower post perimeter curve.
34. Post upper surface.
35. Post lower surface.
36. Post connecting strip joins the post upper and post lower to form the post.
37. The post—used to secure the band to the pick saddle.
38. Post inset connecting strip.
39. Post assembly.
40. Overlap area of the post with the post inset connecting strip.
41. Pick element inset curve.
42. “Zero angle” or “very small” profile angle from side view of thumb
43. “Small profile” angle of thumb
44. “Medium profile” angle of thumb
45. “High profile” angle of thumb
46. Upper encroachment boundary
47. Right hand thumb pick, top view
48. Mirror
49. Left hand pick is the mirror image of a right hand pick.
50. Minimum width between the two opposing post inset longitudinal wall at the point of the maximum width of the post.
51. Maximum width of the post.
52. Wall thickness of pick saddle
53. Flexibility of pick saddle
54. Pick element connecting edge is where the pick element attaches to the pick element inset edge on the outer surface of the pick saddle.
55. Pick element inset edge where the pick element will attach to the saddle outer surface.
56. The two post longitudinal walls determines the width of the post.
57. Opposing post inset longitudinal walls form the opening of the post inset along the length of the post.
58. Pick element upper surface.
59. Pick element lower surface.
60. Origin point
61. Longitudinal line or longitudinal axis, also called the line of symmetry and used to locate the longitudinal plane of symmetry
62. Proximal post boundary points mark the proximal boundary of the post longitudinal walls which are part of the post connecting strip.
63. Proximal post inset boundary points mark the proximal boundary of the post inset longitudinal walls and are part of the post inset connecting strip.
64. Distal post boundary points mark the distal boundary of the post longitudinal walls.
65. Distal post inset boundary points mark the distal boundary of the post inset longitudinal walls.
66. Planes perpendicular to the longitudinal axis, also called cross-sectional planes.
67. Cross-sectional slice; the result of the intersection of a cross-sectional plane with the pick saddle.
68. Longitudinal plane of symmetry
69. Elastic band
70. Portion of minimum width of elastic band.
71. Portion of maximum width of elastic band.
72. Thickness of the elastic band
73. Width of the post plus twice the thickness of the elastic band
74. Pick element of the finger pick of this invention.
75. Wider portion of pick element for a right hand finger on the lateral side of the finger.
76. Narrower portion of pick element for a right hand finger on the medial side of the finger.
77. Direction of travel of a string of a stringed musical instrument across the pick element of a right hand finger pick of this invention.
78. String of a stringed musical instrument.
79. Proximal boundary of the longitudinal line of the foot.
80. Distal boundary of the longitudinal line of the foot.
81. Horizontal trace of a left foot as it would be in a standing position.
82. Horizontal trace of the sole of a shoe last.
83. Medial boundary of the ball joint girth line of a left foot.
84. Lateral boundary of the ball joint girth line of a left foot.
85. Medial boundary of the instep girth line of a left foot.
86. Lateral boundary of the instep girth line of a left foot.
87. Line of the instep.
88. Line of the ball joint.
89. Instep joint at top of foot where the instep measurement originates.
90. Heel line.
91. Ankle line.
92. Proximal node of the longitudinal axis of foot and shoe models.
93. Distal node of the longitudinal axis of foot and shoe models.
94. Joint 1 node is at the medial maximum of the horizontal foot trace.
95. Joint 5 node is at the lateral maximum of the horizontal foot trace.
96. Lower instep node
97. Upper instep node
98. Foot longitudinal axis
99. Foot width line measured as distance between parallel lines that are also parallel to the longitudinal axis, one parallel line passing through the joint 1 node and the other passing through the joint 5 node.
100. Joint line
101. Center joint node.
102. Horizontal foot profile curve of the foot model
103. Vertical profile curve of the foot model
104. Instep axis
105. Instep vertical plane
106. Instep vertical curve
107. Instep girth curve
108. Instep plane
109. Upper heel node
110. Lower heel node
111. Heel girth plane
112. Joint girth plane
113. Heel girth curve
114. Joint girth curve

I claim, in combination:

1. A means of equal distribution of force exerted by a picking device upon a distal digit of a human finger or thumb, said picking device being worn on said distal digit of a player of a stringed musical instrument to aid in the plucking of said stringed instrument, said thumb or said finger having an upper surface, a lower surface, and surface features, said force being exerted to hold said picking device securely upon said distal digit, said means of equal distribution of force comprising
a pick saddle constructed of a sheet of hard material, said pick saddle covering a substantial portion of said upper surface of said distal digit and said pick saddle covering a smaller portion of said lower surface of said distal digit, said pick saddle having an inner surface, said inner surface having an upper portion, said upper portion having surface features which mimic said upper surface features of said distal digit, said inner surface of said pick saddle having a lower portion which gradually encroaches upon said lower surface of said finger or thumb,
and a securing means of said saddle to said distal digit in a manner that said surface features of said inner surface of said saddle are held in close contact with said surface features of said distal digit,
whereby said picking device is very comfortable to the user, does not dislodge from said distal digit of said finger or thumb during use and does not interfere with the travel of a string across said lower surface of said finger or thumb while playing the strings of a stringed musical instrument.

2. A means of equal distribution of force of claim 1 wherein a securing means of claim 1 is an elastic band having a portion of minimum width and a portion of maximum width, a pick saddle of claim 1 having an upper part, a finger or thumb of claim 1 having a lower part, said portion of minimum width of said elastic band being in contact with said upper part of said pick saddle, said portion of maximum width of said elastic band being in contact with said lower part of said finger or thumb,
whereby said elastic band presents a low profile to the strings of a stringed instrument while being played and does not interfere with the travel of instrument strings across the lower part of said finger or thumb.

3. A means of equal distribution of force of claim 2 wherein a pick saddle of claim 2 having a fingertip region, said pick saddle incorporates a pick element at said fingertip region of said pick saddle,
whereby said picking device closely approximates the sound produced by a flat pick in the plucking and strumming of strings of a stringed musical instrument.

4. A means of equal distribution of force of claim 3 wherein said pick element of claim 3 has an upper surface, said upper surface of said pick element having a pick element connecting edge, said pick saddle having an outer surface, said pick saddle outer surface having a pick element inset edge, said upper surface of said pick element being tangent to said pick saddle outer surface at the union of said pick element connecting edge with said pick element inset edge,
whereby instrument strings pass smoothly across said upper surface of said pick element.

5. A means of equal distribution of force of claim 3 wherein a pick saddle of claim 3 incorporates a securing means of an elastic band of claim 3 to said pick saddle, said securing means comprising, in combination, a post and post inset, said post having two opposing post longitudinal walls, said post inset having two opposing post inset longitudinal walls, said pick saddle having an outer surface, said elastic band being threaded around said post and held tightly in place between said post longitudinal walls and said two opposing post inset longitudinal walls, said elastic band being in contact with a substantial portion of said outer surface of said pick saddle,
whereby said elastic band holds said pick saddle securely in place while in use, said post presents a low profile to strings of a stringed instrument while being played, said post and post inset do not present a sharp surface upon which said elastic band will tear, whereby extending the useful life of said elastic band, and said post allows a quick means of replacing said elastic band when said elastic band becomes worn out.

6. A post and post inset of claim 5, said post having a cross-sectional shape and a distal portion, said distal portion having a maximum width,
said post inset having a minimum width,
a pick saddle of claim 5 having an outer surface,
an elastic band of claim 5, said elastic band having a thickness,
said maximum width of said distal portion of said post increased by twice said thickness of said elastic band being greater than said minimum width of said post inset,
whereby said post cannot raise above said outer surface of said pick saddle while in use and therefore cannot interfere with instrument strings while the instrument is played

8. A method of creation of multiple variations of a 3D CAD base model of an item of a human personal nature made to be worn on a part of the human body comprising:
providing 3D CAD software,
providing a 3D CAD base model of an item of a human personal nature
providing a base model pair, said 3D CAD base model pair consisting of
said 3D CAD base model of said item of a human personal nature,
and a 3D CAD base model of said part of the human body,
said 3D CAD base model of an item of a human personal nature or said 3D CAD base model pair having a length, a width, and a height,
said 3D CAD base model of an item of a human personal nature or said 3D CAD base model pair optionally having a profile angle,
said 3D CAD base model of an item of a human personal nature or said 3D CAD base model pair optionally having a wall thickness,
performing, in successive combination, one or more of the following variations of said base model singly, or said base model pair functionally concurrently:
variation of length
variation of width
variation of height
variation of profile angle
variation of mirror image
variation of scale
whereby a multiplicity of 3D CAD models of items of a human personal nature of different sizes and shapes is created, wherein any person can find a single 3D CAD model of an item of human personal nature among said multiplicity of 3D CAD models of items of a human personal nature such that the interior surface of said single 3D CAD model of said item of a human personal nature closely approximates the functional surface of said part of the human body of said any person,
whereby a custom fit item of a human personal nature can then be created by 3d printing, said custom fit item providing a better fit for said any person than said items of a human personal nature manufactured by other methods.

9. A method of creation of multiple variations of a 3D CAD base model of an item of a human personal nature made to be worn on a part of the human body of claim 8,
wherein an item of a human personal nature of claim 8 is a thumb pick to aid in the plucking or strumming of a stringed musical instrument,
wherein a part of the human body of claim 8 is a human thumb.

10. A method of creation of multiple variations of a 3D CAD base model of an item of a human personal nature made to be worn on a part of the human body of claim 8,
wherein an item of a human personal nature of claim 8 is a finger pick to aid in the plucking or strumming of a stringed musical instrument,
wherein a part of the human body of claim 8 is a human finger.

13. A method of creation of multiple variations of a 3D CAD base model of an item of a human personal nature made to be worn on a part of the human body of claim 8,
wherein an item of a human personal nature of claim 8 is an item of footwear,
wherein a part of the human body of claim 8 is a human foot.
